(19) United States
(12) Patent Application Publication
(10) Pub. No.: US 2011/0043446 A1
(43) Pub. Date: Feb. 24, 2011

(54) COMPUTER INPUT DEVICE

(75) Inventors: Iain Spears, Middlesbrough (GB); Timothy Brunton, Middlesbrough (GB); Wen Tang, Middlesbrough (GB)

Correspondence Address: WILMERHALE/BOSTON, 60 STATE STREET, BOSTON, MA, 02109, US

(73) Assignee: University of Teesside, Middlesborough (GB)

(21) Appl. No.: 12/990,769

(22) PCT Filed: May 5, 2009
(86) PCT No.: PCT/GB09/50464

§ 371 Date: Nov. 2, 2010

(30) Foreign Application Priority Data
May 2, 2008 (GB) 0808061.6

(51) Int. Cl. G09G 5/00

(52) U.S. Cl. 345/156

(57) ABSTRACT

Computer input apparatus comprising: an image capture device; and a marker member comprising at least two reference indicia, at least a first reference indicium being arranged to emit or reflect light having a first spectral characteristic, and at least a second reference indicium being arranged to emit or reflect light having a second spectral characteristic different from the first spectral characteristic, the image capture device being arranged to distinguish light of said first spectral characteristic from light of said second spectral characteristic thereby to distinguish the at least a first reference indicium from the at least a second reference indicium, the apparatus being configured to capture an image of the at least two reference indicia and to determine by means of said image a position and orientation of the marker member with respect to a reference frame.

### FIELD OF THE INVENTION

The present invention relates to an input device for a computer. In particular but not exclusively the invention relates to an input device to be worn by or held by a user.

### BACKGROUND

A variety of computer input devices are known arranged whereby manual manipulation of the device allows one or more commands to be transmitted to a computer. Examples include a mouse, touch screen, touch pad, joystick and other controllers.

US2007/0049374 (NINTENDO) discloses a game system having a pair of controllers arranged to be held one in a left hand and one in a right hand of a user. One controller has an acceleration sensor and an image pickup section that includes a camera. A pair of infra-red light emitting diodes (LEDs) are provided on a monitor of the game system. The system is arranged to process an image acquired by the image pickup section and to detect a position of the LEDs within the image. Movement of the controller can result in a change of position of one or both of the LEDs in the image, which can be detected by the system thereby to determine movement of the controller.

WO2005/073838 (SONY) discloses a handheld light input device for a computing device including an LED and a mode change activator arranged to change a colour of light emitted by the LED upon activation by a user. A camera fixed to a monitor acquires an image of the input device and the computing device detects a colour of the LED and movement of the LED within the image. The document discloses detection of movement of the device in two dimensions only.

None of the documents discloses a system allowing detection of movement of an input device in three mutually orthogonal directions.

Systems are known that allow a position and orientation of an object to be determined with six degrees of freedom (6 DOF) based on an image of a marker affixed to the object, the image being captured by an image capture device. Such systems are limited in the range of angles of the marker with respect to the camera over which orientation of the object can be determined. Known systems also have a limited range of operation in terms of the distance from the camera to the marker.

### STATEMENT OF THE INVENTION

In a first aspect of the invention there is provided computer input apparatus comprising: an image capture device; and
a marker member comprising at least two reference indicia,
at least a first reference indicium being arranged to emit or reflect light having a first spectral characteristic, and
at least a second reference indicium being arranged to emit or reflect light having a second spectral characteristic different from the first spectral characteristic,
the image capture device being arranged to distinguish light of said first spectral characteristic from light of said second spectral characteristic thereby to distinguish the at least a first reference indicium from the at least a second reference indicium,
the apparatus being configured to capture an image of the at least two reference indicia and to determine by means of said image a position and orientation of the marker member with respect to a reference frame.

Preferably light of the first spectral characteristic corresponds to light of a first colour and light of the second spectral characteristic corresponds to light of a second colour different from the first colour.

Preferably the first and second colours are each a different one selected from amongst red, green and blue.

The apparatus may comprise at least a third reference indicium arranged to emit or reflect light of a third spectral characteristic.

The third spectral characteristic may correspond substantially to the first or second spectral characteristics.

Alternatively the third spectral characteristic may be sufficiently different from the first and second spectral characteristics to be distinguishable by the image capture device from indicia emitting or reflecting light of the first or second spectral characteristics.

The third spectral characteristic may correspond to a colour.

The colour may be one selected from amongst red, green and blue.

Preferably beams of light of the first, second and third spectral characteristics each correspond to a different respective colour.

The first, second and third reference indicia may be arranged to be non-colinear.

The image capture device is preferably provided with a plurality of detector elements,
a first detector element being responsive to wavelengths in a first range of wavelengths, the apparatus being operable to acquire a first image by means of the first detector element, and
a second detector element being responsive to wavelengths in a second range of wavelengths different from the first range of wavelengths,
the apparatus being operable to acquire a second image by means of the second detector element, wherein the first range of wavelengths includes at least some wavelengths of the first spectral characteristic and the second range of wavelengths includes at least some wavelengths of the second spectral characteristic.

Preferably the first spectral characteristic and the first and second ranges of wavelengths are selected such that for a given intensity of light emitted or reflected by the at least a first indicium, an intensity of light detected by the first detector element from the at least a first indicium is greater than an intensity of light detected by the second detector element from the at least a first indicium.

Preferably the apparatus is arranged whereby the second spectral characteristic and the first and second ranges of wavelengths are selected such that for a given intensity of light emitted or reflected by the at least a second indicium, an intensity of light detected by the second detector element from the at least a second indicium is greater than an intensity of light detected by the first detector element from the at least a second indicium.

The apparatus may be arranged to determine a position in the first image of a centroid of a portion of the first image corresponding to the at least a first indicium and a position in the second image of a centroid of a portion of the second image corresponding to the at least a second indicium.

Preferably the image capture device comprises a third detector element responsive to wavelengths in a third range of wavelengths and arranged to capture a third image, the third range of wavelengths including at least some wavelengths of the third spectral characteristic.

The apparatus may be arranged whereby the first spectral characteristic and the first, second and third ranges of wavelengths are selected such that for a given intensity of light emitted or reflected by the at least a first indicium, an intensity of light detected by the first detector element from the at least a first indicium is greater than an intensity of light detected by the second or third detector elements from the at least a first indicium;
the second spectral characteristic and the first, second and third ranges of wavelengths are selected such that for a given intensity of light emitted or reflected by the at least a second indicium, an intensity of light detected by the second detector element from the at least a second indicium is greater than an intensity of light detected by the first or third detector elements from the at least a second indicium; and
the third spectral characteristic and the first, second and third ranges of wavelengths are selected such that for a given intensity of light emitted or reflected by the at least a third indicium, an intensity of light detected by the third detector element from the at least a third indicium is greater than an intensity of light detected by the first or second detector elements from the at least a third indicium.

One reference indicium may be arranged to be of a larger area another reference indicium whereby occlusion of an image of the one reference indicia by the other reference indicium may be substantially avoided.

The apparatus may be configured to detect an area of overlap in an image of two or more of the indicia by determining a location of any area of increase in light intensity in a captured image due to overlap of indicia.

The apparatus may be arranged to determine a centroid of an area of the captured image corresponding to one of the indicia by reference to any said area of overlap between the area corresponding to the one indicium and an area corresponding to another indicium, and an area of the image corresponding to said one of the indicia that is not overlapping an area corresponding to said another one of the indicia.

The marker member may be arranged to be held in a hand of a user.

Alternatively the marker member may be arranged to be attached to a user.

The marker member may be arranged to be positioned whereby a pair of the reference indicia are provided in a mutually spaced apart configuration substantially coincident with an axis of rotation of an anatomical joint.

The marker member may be arranged whereby the first and second reference indicia are provided in the mutually spaced apart configuration substantially coincident with the axis of rotation of the anatomical joint.

The axis of rotation may correspond to an abduction-adduction axis of the wrist.

The axis of rotation may correspond to one selected from amongst a carpo-1^{st} metacarpal joint and a second metacarpal-phalangeal joint.

The image capture device may be provided with a polarising element arranged to reduce an amount of light incident on a detector of the image capture device.

At least one of the reference indicia may comprise a light source.

Each of the reference indicia may comprises a light source.

A size of an area of the image captured by the apparatus corresponding to one or more of the reference indicia may be expanded relative to a corresponding area of a portion of an image of the reference indicia that would be obtained under in-focus conditions whereby a position of a centroid of each of the one or more reference indicia in the image may be determined with increased precision.

Expansion of the area of the image corresponding to the one or more of reference indicia may be obtained by defocus of the image.

Defocus of the image may be performed by optical means.

Alternatively or in addition defocus of the image may be performed electronically.

An intensity of light emitted or reflected by at least one of the indicia may be changed whereby the apparatus is able to identify which indicium a portion of an image corresponds to by means of a prescribed change in intensity of light emitted or reflected by the at least one of the indicia.

The apparatus may comprise a plurality of image capture devices.

At least a first image capture device may be arranged to capture an image from a region of space not captured by at least a second image capture device.

The regions of space captured by the at least a first image capture device and the at least a second image capture device may have at least a portion in common.

In a second aspect of the invention there is provided computer input apparatus comprising: an image capture device; and a marker member comprising at least three non-colinear reference indicia, the marker member being arranged to be held by a user or attached to a body of a user such that a pair of reference indicia are provided in a mutually spaced apart configuration substantially coincident with an anatomical axis of rotation of a joint of the user, the apparatus being configured to capture an image of the reference indicia and to determine a position and orientation of the marker member with respect to a reference position.

Preferably the structure is arranged such that one of each of the pair of reference indicia are provided at locations substantially coincident with the axis of rotation, the pair of reference indicia being axially spaced with respect to one another.

Preferably the apparatus is configured to form an image of the reference indicia wherein an area of the image occupied by at least one of the indicia is expanded relative to a corresponding area of an image of the indicia under in-focus conditions whereby a position of a centroid of the area of the image occupied by each of the indicia may be determined with increased precision.

The anatomical axis of rotation may correspond to an abduction-adduction axis of the wrist.

Alternatively the anatomical axis of rotation may correspond to a carpo-1^{st} metacarpal joint.

Alternatively the anatomical axis of rotation may correspond to a second metacarpal-phalangeal joint.

The apparatus may be arranged to be held in a hand of the user.

Alternatively the apparatus may be arranged to be attached to a head of the user.

The apparatus may comprise a plurality of marker members.

The apparatus may comprise a pair of marker members arranged to be held in respective left and right hands of the user.

The apparatus may comprise at least one marker member arranged to be held in a hand of the user and a marker member arranged to be supported on a head of the user.

Preferably the apparatus is further configured such that a size of an area of the image captured by the apparatus corresponding to one or more of the reference indicia is expanded relative to a corresponding area of a portion of an image of the reference indicia that would be obtained under in-focus conditions whereby a position of the centroid of each of the one or more reference indicia in the image may be determined with increased precision.

Preferably expansion of the area of the image occupied by the at least one indicia is obtained by defocus of the image.

Preferably defocus of the image is performed by optical means.

Alternatively or in addition defocus of the image may be performed electronically.

Preferably at least one of the reference indicia comprises a light source.

Preferably the at least three non-colinear reference indicia are provided by a first light source, a second light source and a third light source, respectively.

### BRIEF DESCRIPTION OF THE DRAWINGS

Embodiments of the invention will now be described with reference to the accompanying figures in which:

FIG. 1 shows a side view of a pointing device according to an embodiment of the invention;

FIG. 2 shows a portion of an image captured by an image capture device showing a user holding a pointing device according to the embodiment of FIG. 1;

FIG. 3 is a schematic illustration showing a frame of reference of a user holding a pointing device according to the embodiment of FIG. 1;

FIG. 4 shows portions of an as-captured image showing (a) red, green and blue colour planes of the image superimposed; (b) only the green image plane and (c) only the blue image plane;

FIG. 5 is a plan view (i.e. a view along a y-axis) of the image capture device and pointing device;

FIG. 6 is a schematic illustration of an image captured by the image capture device of the arrangement of FIG. 5;

FIG. 7 shows (a) a further plan view of the image capture device and pointing device of FIG. 5 and (b) a close-up view of the pointing device showing certain angles and dimensions;

FIG. 8 is a schematic illustration of an image captured by the image capture device in the arrangement of FIG. 7;

FIG. 9 is a further plan view of the image capture device and pointing device of FIG. 5;

FIG. 10 is a schematic illustration of an image captured by the image capture device in the arrangement of FIG. 9;

FIG. 11 shows (a) an image captured by the image capture device and (b) a virtual vector (P″), an origin of the local coordinate system being a point midway between first and second light emitting devices;

FIG. 12 shows a further plan view of the image capture device and pointing device of FIG. 5;

FIG. 13 shows a series of traces corresponding to translational movement of a pointing device in directions parallel to the x, y and z-axes;

FIG. 14 shows a series of traces corresponding to rotational movement of a pointing device about the x, y and z-axes;

FIG. 15 is a schematic illustration of a wrist of a user showing an axis of flexion-extension FE, an axis of abduction-adduction AA and the approximate location of an axis of pronation-supination (PS) being an axis arranged to pass from an elbow joint along a length of a lower arm;

FIG. 16 shows a portion of an image captured by the image capture device showing overlap of images of light emitting devices of the apparatus emitting light of the same colour;

FIG. 17 is a schematic illustration of a hand of a user showing (a) axes of flexion-extension and abduction-adduction of the carpo-1^{st} metacarpal joint (i.e. thumb) and (b) axes of flexion-extension and abduction-adduction of the 2^{nd} metacarpal-phalangeal joint (i.e. an index finger);

FIG. 18 shows a pointing device according to an embodiment of the invention;

FIG. 19 shows a further pointing device according to an embodiment of the invention;

FIG. 20 shows a pointing device according to a further embodiment of the invention;

FIG. 21 illustrates a problem of occlusion of an image of a reference indicium;

FIG. 22 shows a pointing device according to an embodiment of the invention;

FIG. 23 shows apparatus having two image capture devices;

FIG. 24 shows (a), (b) known object tracking apparatus and (c), (d) image capture devices in a configuration suitable for use in an embodiment of the invention;

FIG. 25 shows a miniature marker member according to an embodiment of the invention;

FIG. 26 shows a miniature marker member being used to transmit signals indicative of an event;

FIG. 27 shows images captured by an image capture device showing (a) green and blue image planes combined in a single image, (b) an image obtained using detectors of the image capture device arranged to detect green light and (c) an image obtained using detectors of the image capture device arranged to detect blue light; and

FIG. 28 shows (a) forward-throw and capture-source axes of an arrangement having a light emitting device and an image capture device and (b) a plot of normalised light intensity as a function of angular displacement for one particular type of light emitting device.

### DETAILED DESCRIPTION

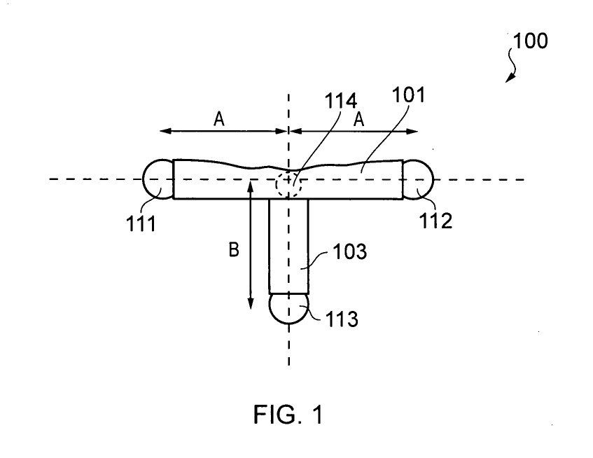

FIG. 1 shows a handheld pointing device 100 of an embodiment of the invention. The device has a grip portion 101 arranged to be gripped in a palm of a user's hand and a pointer portion 103 arranged to protrude in a generally radial direction from the grip portion 101. First and second light emitting diodes (LEDs) 111, 112 are provided at opposite ends of the grip portion 101 whilst a third LED 113 is provided at a free end of the pointer portion 103. In the embodiment of FIG. 1 the first and second LEDs 111, 112 are arranged to emit blue light whilst the third LED 113 is arranged to emit green light.

Other configurations of the pointing device 100 are also useful in which three or more non-colinear light emitting devices or other indicia are provided. Other colours and combinations of colours of the LEDs are also useful. In some embodiments more than three light sources are used. Light sources other than LEDs are also useful.

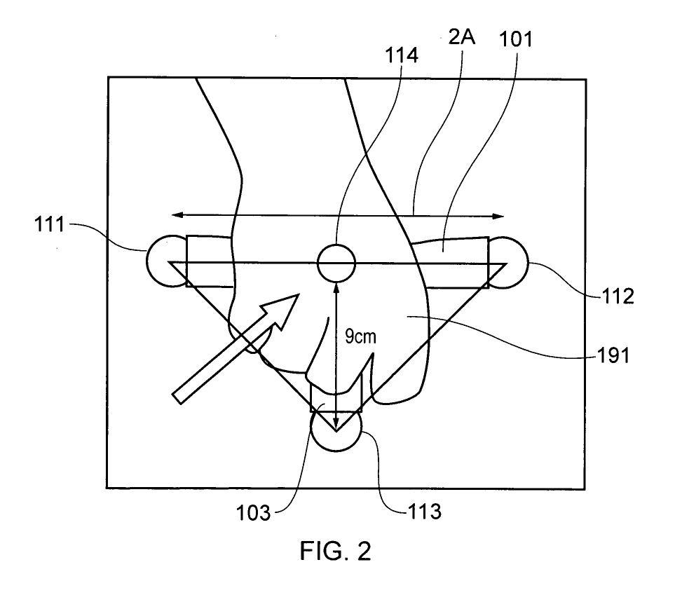

FIG. 2 shows the pointing device 100 of FIG. 1 being held in the hand 191 of a user. The pointing device is shaped to fit in the hand 191 of a user such that the first LED 111 may be positioned behind the user's wrist joint whilst the second LED 112 may be positioned ahead of the user's wrist joint as shown in FIG. 2. In the embodiment shown the pointer portion 103 is arranged to protrude from between the user's middle and index fingers when the device 100 is held.

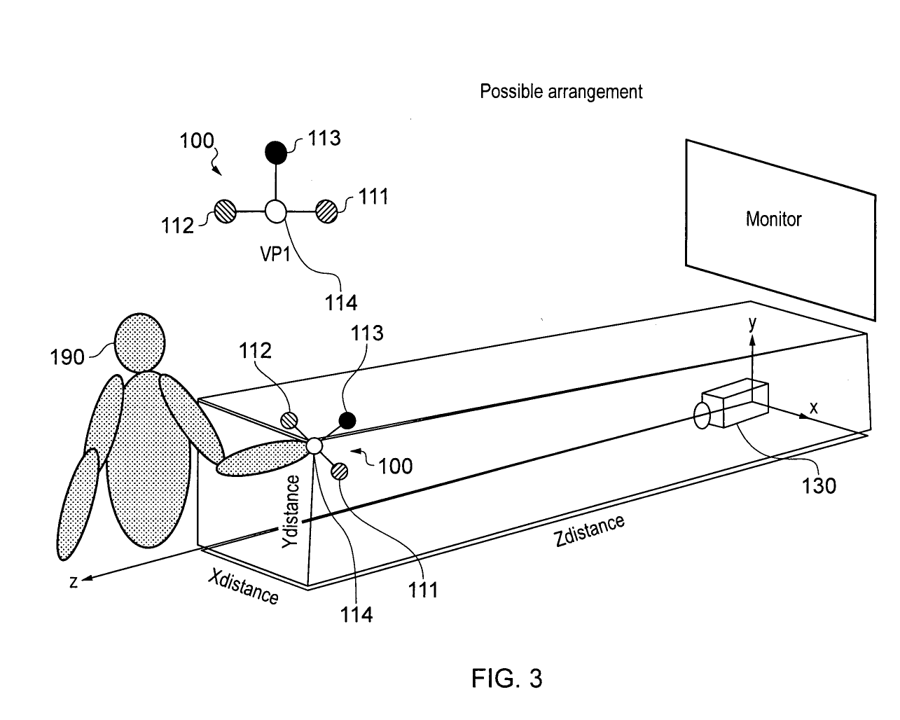

FIG. 3 shows an arrangement of the apparatus in use. In the arrangement of FIG. 3 a user 190 is shown standing in front of an image capture device 130 holding the pointing device 100. A frame of reference with respect to the position and orientation of the image capture device 130 is also shown. A z-axis of the frame of reference is coincident with an optic axis of the image capture device. An x-axis and a y-axis are arranged to be mutually orthogonal to one another and to the z-axis.

The image capture device 130 is arranged to capture an image of the pointing device 100 and the apparatus is arranged to store the captured image in a memory. The image capture device 130 is a colour image capture device arranged to provide an output of information corresponding to an amount of red light, an amount of green light and an amount of blue light incident on a detector of the device 130. In the embodiment of FIG. 1 the image capture device 130 is arranged to capture an out-of-focus image of the pointing device 100.

The out-of-focus image is arranged whereby the area of the captured image in which an image of an LED 111, 112, 113 is formed is enlarged (expanded) relative to an area of the captured image that would otherwise be occupied by an image of an LED 111, 112, 113 if the image were obtained under in-focus conditions.

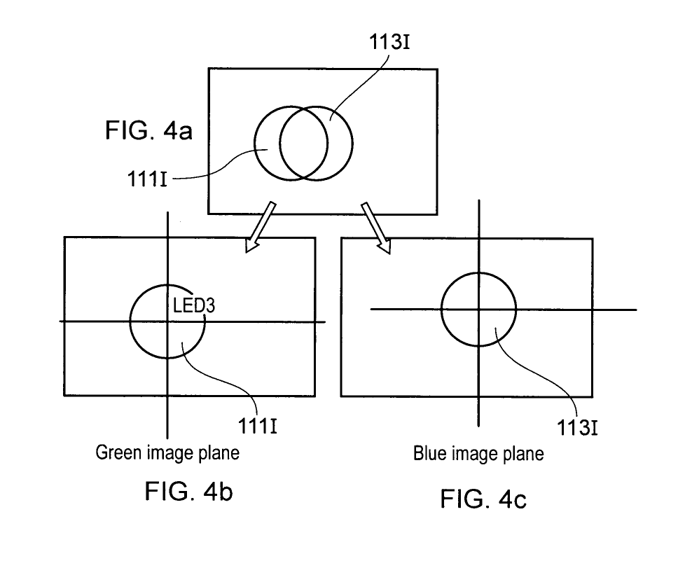

An example of a portion of an image captured by the image capture device 130 is shown in FIG. 4. At the time the image was captured, the pointing device 100 was oriented at an oblique angle to the image capture device 130 such that the expanded images 111I, 113I of the first and third LEDs 111, 113 overlapped with one another.

FIG. 4(a) shows a portion of the as-captured (colour) image with information corresponding to an amount of any red, green and blue light emitted by the first and third LEDs 111, 113. When the image was captured the third LED 113 was positioned closer to the camera than the first LED 111 and thus it can be appreciated that the image of the first LED 111I is partially ‘occluded’ by the image of the third LED 113I.

However, since the apparatus is arranged to obtain information corresponding to an amount of green light incident on the detector and separate information corresponding to an amount of blue light incident on the detector, the apparatus is able to generate separate images 111I, 113I of the green LED 111 (first LED 111) and blue LED 113 (third LED 113) as shown in FIG. 4(b) and FIG. 4(c), respectively.

It can be seen from FIG. 4 that separation of information in the image of FIG. 4(a) according to colour associated with the image enables an outline of the portions 111I, 113I of the image corresponding to each of the first and third LEDs 111, 113 respectively to be determined more accurately. This in turn enables the centroid of each of the portions 111I, 113I to be determined more accurately.

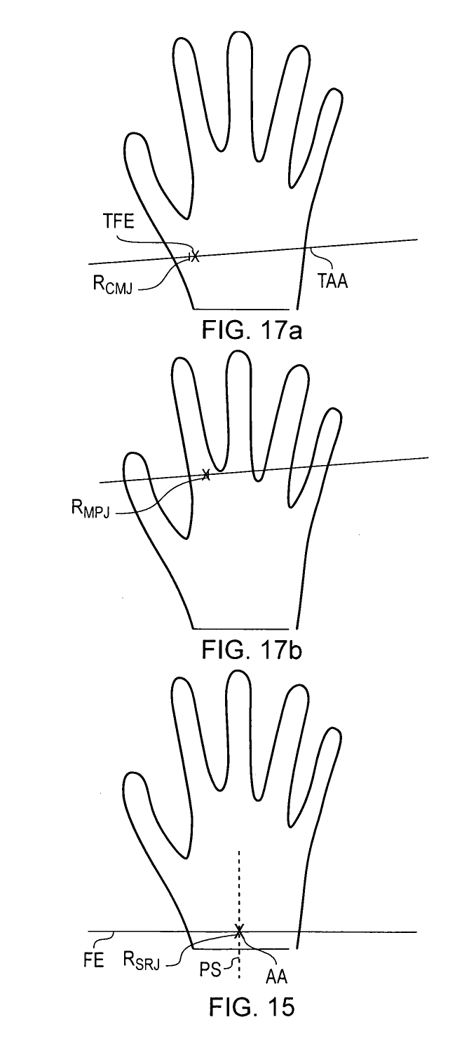

As discussed above, the pointing device 100 of the embodiment of FIG. 1 is arranged to be held in a palm of a user's hand 191 (FIG. 2). The device 100 is configured whereby the first and second LEDs 111, 112 are located at positions axially spaced along a flexion-extension (FE) axis or rotation of the user's wrist (FIG. 15). A midpoint (being a virtual point 114) between the first and second LEDs 111, 112 coincides approximately with the abduction-adduction (AA) axis of rotation of the wrist, the AA axis being an axis normal to the FE axis of rotation and normal to the plane of the page of FIG. 15.

It is to be understood that in some alternative embodiments the first and second LEDs 111, 112 are axially spaced along the AA axis. In some such embodiments the position of the FE axis is estimated as passing through a mid-point of the AA axis normal to the AA axis and in the plane of the page of FIG. 15.

In some embodiments of the invention, in determining a position and orientation of the pointing device 100 reference is made to the location of the virtual point 114. It will be appreciated that the position of the virtual point 114 may be determined provided the positions of the first and second LEDs 111, 112 are known.

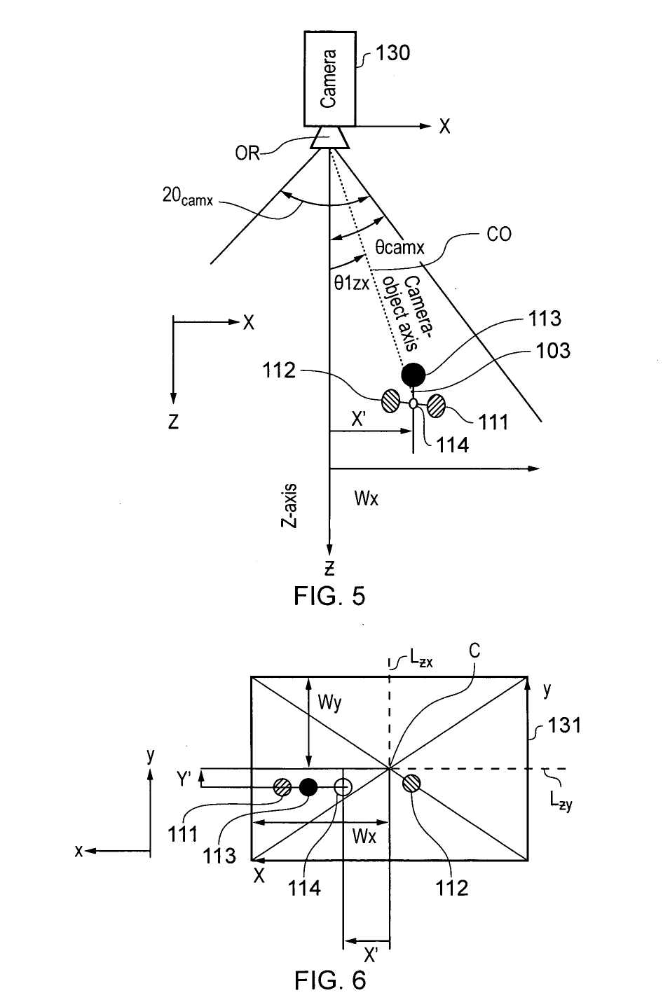

FIG. 5 shows a geometrical configuration of a pointing device 100 provided within a field of view of an image capture device 130. In determining an orientation of the pointing device 100 with respect to the frame of reference of FIG. 3 the apparatus is arranged to process an image captured by the image capture device 130 in order to determine an angle θ_{1zx} being a projected angle in the (x, z) plane between the z-axis and a camera-object axis CO being a line from origin OR to the virtual point 114.

Since the camera viewing angle in the (x, z) plane 2θ_{camx} is constant and known, an angle θ_{1zx} being a projected angle in the (x, z) plane between the z-axis and the camera-object axis may be determined from a knowledge of the position in the captured image 131 (FIG. 6) of the virtual point 114 with respect to a centre C of the image 131.

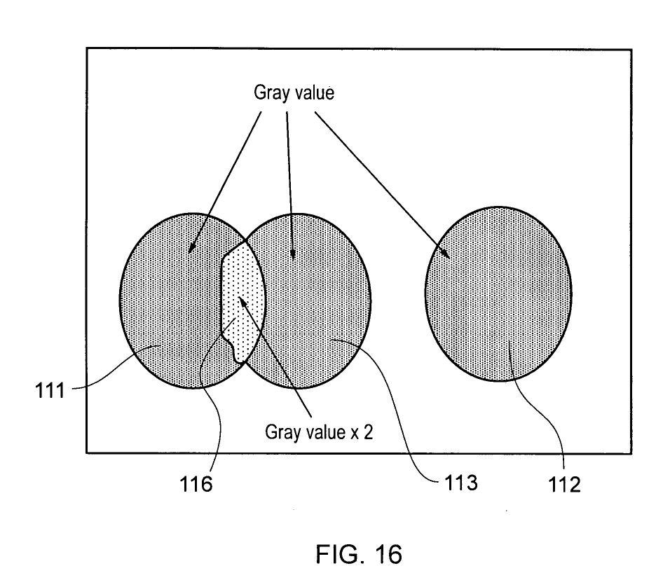

Thus, if the position of the virtual point 114 in the captured image lies along a line L_{zx} (FIG. 16) being a line through the centre C of the image 131 in a direction parallel to the y-axis of the reference coordinates it may be determined that the angle θ_{1zx} is substantially zero.

However, if the position of the virtual point 114 in the captured image lies at a position away from line L_{zx} in a direction parallel to the x-axis by a number of pixels X″ then angle θ_{1zx} may be determined by the equation:

θ_{1zx}=X″·θ_{camx}/Wₓ

where Wₓ is half the width of the captured image in units of a pixel.

Similarly, since the camera viewing angle in the (y, z) plane 2θ_{camy} is constant and known, an angle θ_{1zy} being an angle in the (y, z) plane between the z-axis and a line from virtual point 114 (FIG. 5) to origin OR may be determined from a knowledge of the position of the virtual point 114 in the captured image 131 with respect to a centre C of the image 131.

If the position of the virtual point 114 in the captured image 131 lies along a line L_{zy} being a line through the centre C of the image 131 in a direction parallel to the x-axis of the reference coordinates it may be determined that the angle θ_{1zy} is substantially zero.

However if the position of the virtual point 114 in the captured image 131 lies at a position away from line L_{zy} in a direction parallel to the y-axis by a number of pixels Y″ then angle θ_{1zy} is given by the equation:

θ_{1zy}=Y″·θ_{camy}/W_{y}

where W_{y} is half the width of the captured image in units of a pixel.

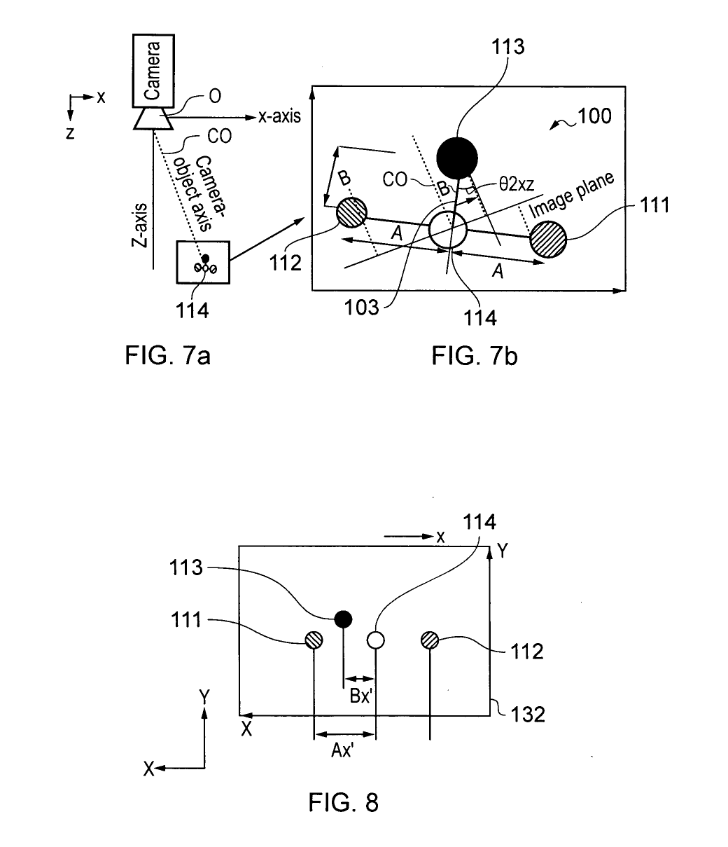

In order to calculate a rotational orientation of the pointing device 100 with respect to the frame of reference of FIG. 3 an angle of the pointing device 100 with respect to a camera-object axis CO is first calculated (FIG. 7). The CO axis is defined by a line from the origin O to the virtual point 114 of the device 100.

A distance between the virtual point 114 and the third LED 113 is given by B, whilst a distance from the virtual point 114 to each of the first and second LEDs 111, 112 is given by A (FIG. 7(b)).

An angle between a longitudinal axis of the pointer portion 103 and the CO axis in the (x, z) plane θ_{2xz} (FIG. 7(b)) is given by:

tan θ_{2xz}=(A·Bx″)/(Ax″·B)

where Ax″ and Bx″ are the projections along the x-axis of lengths A and B in image 132 (FIG. 8) captured by the image capture device 130.

It will be understood that this calculation can be repeated with reference to the (y, z) plane to determine an angle between the longitudinal axis of the pointer portion 103 and the CO axis in the (y, z) plane θ_{2yz}:

tan θ_{2yz}=(A·By″)/(Ay″·B)

where Ay″, By″ are the projections along the y-axis of lengths A and B in image 132 (FIG. 8) captured by the image capture device 130.

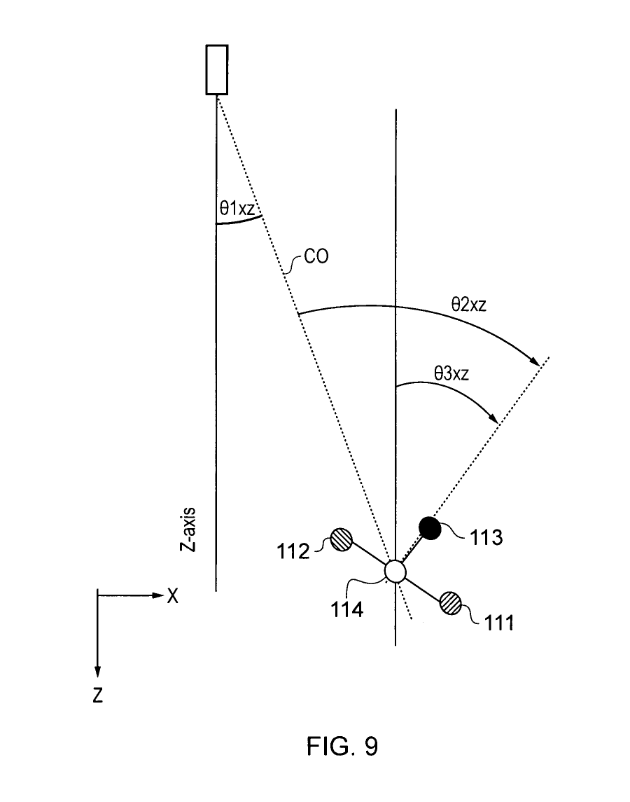

Having calculated the orientation of the pointing device 100 with respect to a camera-object axis (CO) the orientation of the device 100 with respect to the z-axis may be calculated in both the (x, z) and (y, z) planes. With reference to FIG. 9:

θ_{3xz}=θ_{2xz}−θ_{1xz}

where θ_{3xz} is the local orientation of a projection of the object in the (x, z) plane with respect to the z-axis of the image capture device 130. A corresponding calculation may be made with respect to the (y,z) plane.

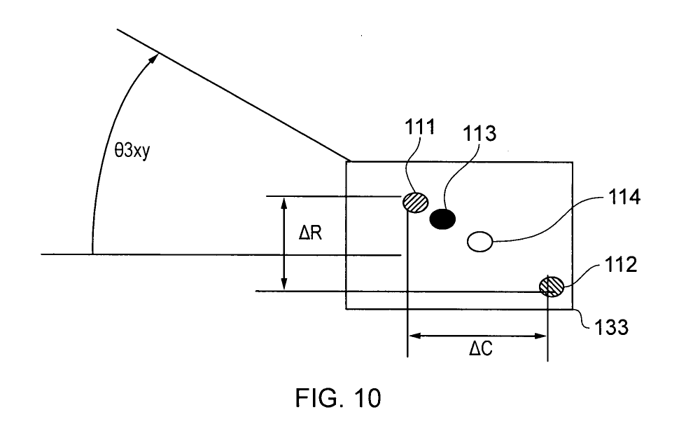

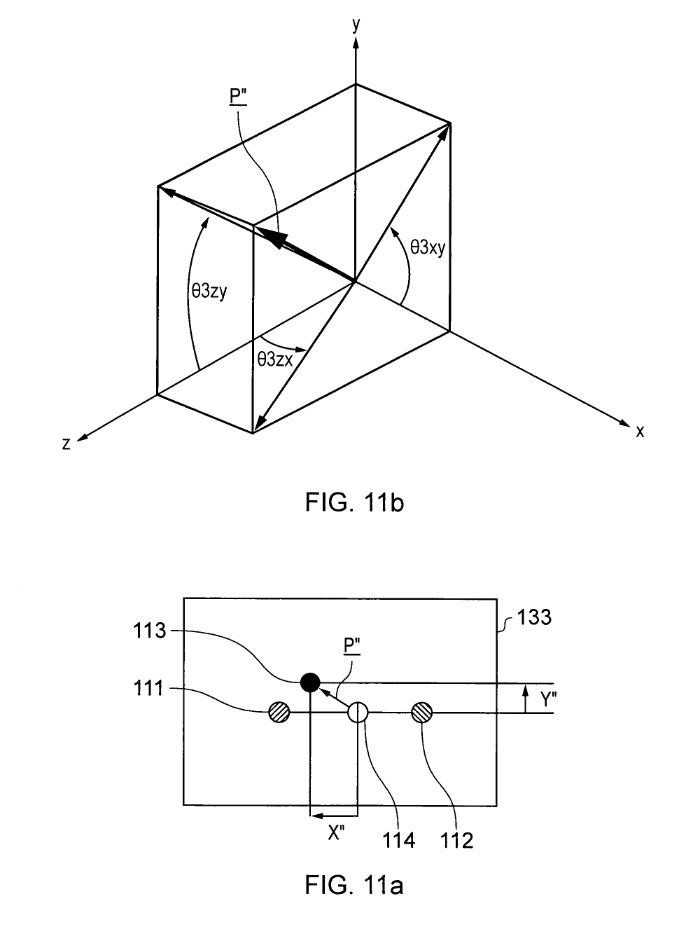

FIG. 10 shows an image 133 captured by the image capture device 130 from which a tilt angle of the pointing device 100 about the z-axis, θ_{3xy} may be calculated:

tan θ_{3xy}=ΔR/ΔC

where ΔR is the number of rows of pixels between the centroids of the first and second LEDs 111, 112 in the captured image 133 and ΔC is the number of columns of pixels between the centroids of the first and second LEDs 111, 112 in the captured image 133.

Finally, the distance of the pointing device 100 from the image capture device 130 is calculated as follows.

A line connecting virtual point 114 and the centroid of the third LED 113 at the actual pointing device 100 may be defined by a three-dimensional vector P of known magnitude. In some embodiments the magnitude of vector P is around 9 cm. Ignoring the local effects of perspective, vector P may be considered equal to a virtual vector P″ multiplied by a scaling factor K. Thus, vector P may be written:

P=KP″

Virtual vector P″ may be defined in terms of captured image 133 (and have units of pixels) whereby a line in captured image 133 from the image of virtual point 114 to the centroid of the image of the third LED 113 provides a projection of virtual vector P″ onto the (x,y) plane.

FIG. 11(a) shows an image captured by the image capture device 130 showing the first, second and third LEDs 111, 112, 113. The position of virtual point 114 is also indicated in the figure, together with the position of virtual vector P″.

FIG. 11(b) shows the virtual vector P″ beginning at virtual point 114. It is to be understood that the origin of the local coordinate system shown in FIG. 11(b) is the virtual point 114.

The scaling factor K is dependent on the focal length of the camera (a constant) and is linearly related to the distance of the pointing device 100 from the image capture device 100.

Virtual vector P″ may be written:

P″=X″i+Y″j+Z″k

where X″ is the number of columns between the third LED 113 and virtual point 113, and Y″ is the number of rows between the third LED 113 and third LED 113.

Z″ may then be calculated using one of two equations:

Z″=X″/tan(θ_{3zx}); and

Z″=Y″/tan(θ_{3zy})

Thus a check of the validity of one or more parameters calculated by the apparatus may be performed.

The magnitude of the virtual vector may then be calculated using the equation:

|P″|=(X″²+Y″²+Z″²)^{1/2}

The scaling factor K between the virtual vector P″ and vector P may then be calculated:

K=|P|/|P″|

The distance (Z) of the virtual point 114 from the image capture device 130 can then be calculated as follows:

Z=1/K

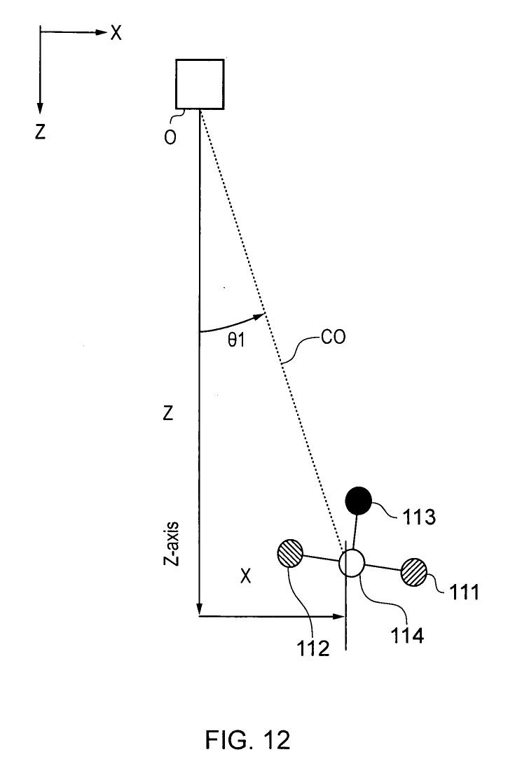

Finally, with reference to FIG. 12 the position of the pointing device 100 with reference to the x, y axes is given of the form:

X=|Z|·tan(θ_{1xz})

Y=|Z|·tan(θ_{1yz})

Where X is the x-coordinate of the virtual point 114 (FIG. 12) and Y is the y-coordinate of the virtual point 114.

### Example 1

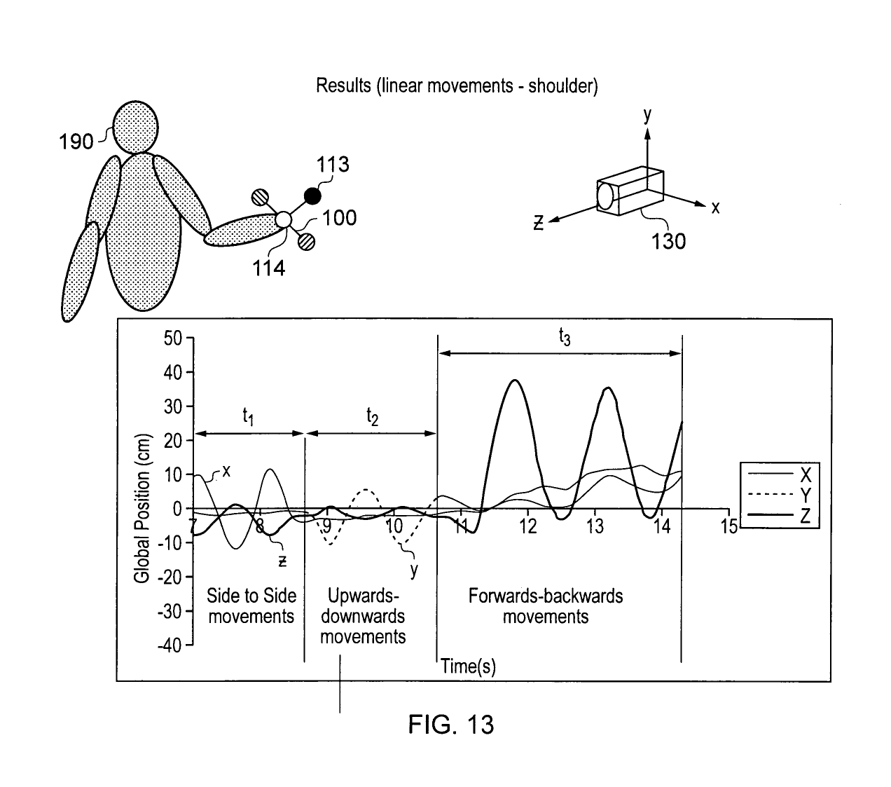

FIG. 13 shows a graph of movement of a pointing device 100 relative to an image capture device 130 using apparatus of an embodiment of the invention. The image capture device 130 was a 640×480 pixel webcam device of the type used in typical internet-based communication applications.

Three separate traces are shown in the graph. Trace X corresponds to a position of the virtual point 114 with respect to the origin O along the x-axis. Trace Y corresponds to a position of the virtual point 114 with respect to the origin O along the y-axis and trace Z corresponds to a position of the virtual point 114 with respect to the origin O along the z-axis.

With respect to a user 190 positioned as shown in FIG. 13, the form of trace X in the graph of FIG. 13 therefore corresponds to side-to-side movement of pointing device 100 (i.e. movement along the x-axis only). Trace Y corresponds to upwards-downwards movement of the pointing device 100 (i.e. movement along the y-axis only) whilst trace Z corresponds to movement of the pointing device towards and away from the image capture device 130 (i.e. movement along the z-axis only).

During time period t₁ user 190 gripped the pointing device 100 and attempted to execute only side-to-side movement of his/her hand. It can be seen that the amplitude of oscillation of trace X is larger than that of other traces. It can also be seen however that trace Z exhibits a not insignificant amplitude of oscillation that is of the same frequency as trace X indicating that the user had difficulty preventing movement of the pointing device towards and away from the image capture device 130 as the user attempted to cause only side-to-side movement of the pointing device 100. This is most likely because linear side-to-side movement of the pointing device in fact requires a user to rotate his/her shoulder.

During time period t₂ the user attempted to move the pointing device only in an upwards-downwards direction As expected, trace Y has the largest amplitude of oscillation, corresponding to such movement, although trace Z shows a corresponding oscillation indicating corresponding movement of the device towards and away from the image capture device 130 during period t₂.

During time period t₃ the user attempted forwards-backwards movement of the pointing device 100 and corresponding trace Z indicates that movement along the z-axis was the movement of the highest amplitude.

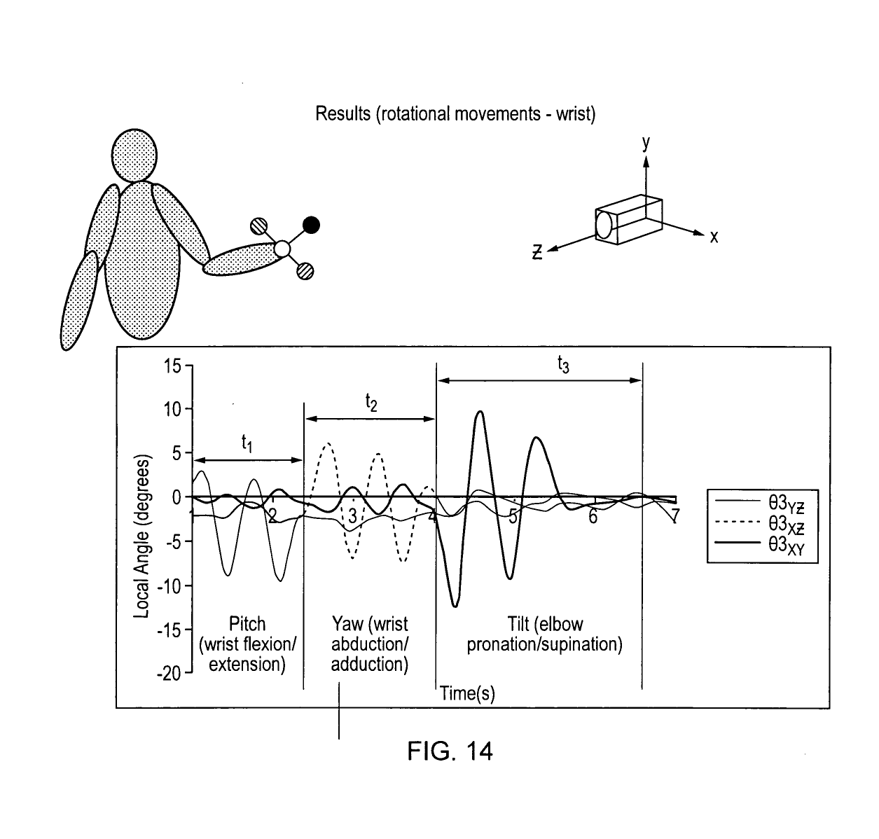

FIG. 14 shows a corresponding graph of rotational movement of the pointing device. Trace θ_{3yz} corresponds to rotation about the FE axis which is performed by wrist flexion/extension, i.e rotation of the wrist with the FE axis of FIG. 15 as pivot axis. This may be described as a ‘pitching’ motion of the wrist.

Trace θ_{3xz} corresponds to rotation about the abduction-adduction axis AA of the wrist (a ‘yawing’ motion of the wrist) as shown also in FIG. 15 as discussed above.

Trace θ_{3xy} corresponds to rotation about the z-axis which is performed by elbow pronation/supination (a ‘tilting’ motion of the lower arm) being a twisting action of the lower arm about the PS axis of FIG. 15.

During time period t₁ the user 190 gripped the pointing device 100 and attempted to rotate the pointing device only about the FE axis, which in the arrangement of FIG. 14 corresponds to only pitching movement of the wrist. It can be seen that the amplitude of oscillation of trace θ_{3yz} is larger than that of the traces θ_{3xz} and θ_{3xy} although traces θ_{3xz} and θ_{3xy} show a variation in amplitude of a similar frequency to trace θ_{3yz}. The results indicate that the apparatus has also detected rotational movement of the pointing device about the AA and PS axes as the user attempted to cause only rotation of the pointing device 100 about the FE axis.

It is to be understood that the amount of rotation about detected by the apparatus about the AA and PS axes is less than that which would be in principle detected in apparatus in which the first and third light emitting devices are not located substantially along the FE axis of rotation of the wrist joint.

During time period t₂ the user 190 attempted to rotate the pointing device only about the AA axis. As expected, trace θ_{3xz} has the largest amplitude of oscillation, corresponding to such movement, although trace θ_{3xy} shows a corresponding oscillation indicating rotation of the device about the PS-axis also occurred to a not insignificant extent.

During time period t₃ the user 190 attempted to rotate the pointing device only about the PS axis. As expected, trace θ_{3xy} has the largest amplitude of oscillation, corresponding to such movement. A small amount of oscillation about the FE and AA axes is also apparent from the amplitudes of oscillation of traces θ_{3yz} and θ_{3xz}, respectively.

In some embodiments of the invention the pointing device is provided with further user input elements such as one or more control buttons, a joystick or any other suitable elements.

In some embodiments of the invention two or more pointing devices are provided. In some embodiments a pointing device is provided for each hand of a user using the apparatus.

In some embodiments the light emitting devices of the two or more pointing devices are arranged whereby each device may be uniquely identified by a portion of the apparatus processing images captured by the image capture device. By way of example, in some embodiments of the invention an arrangement of at least one selected from amongst different colours, different intensities of light emission, different frequencies or patterns of variation of intensity and/or colour of light emitting devices of each pointing device are arranged to be uniquely identifiable with respect to one another.

Thus, in some embodiments an intensity of light emission by one or more of the light emitting devices of a given pointing device is modulated. In some embodiments modulation of the intensity of one or more of the light emitting devices in combination with devices of a plurality of colours enables each of the light emitting devices to be uniquely identified.

In some embodiments of the invention the light emitting devices are arranged to emit light of substantially the same frequency (or spectrum of frequencies). In some such embodiments the intensity of light emission emitted by different respective devices allows each of the light emitting devices to be uniquely identified. In some embodiments unique identification is achieved by modulating the intensity of light emission of one or more of the devices.

In some embodiments of the invention expansion of the area of a captured image corresponding to each light emitting device is performed optically, for example by adjusting a position of the focal point of a lens of the image capture device with respect to an image capture surface of the image capture device. In some embodiments expansion of the area of a captured image corresponding to the light emitting device is performed electronically rather than by optical means. For example, a blurring or other algorithm may be applied to a dataset representing the captured image.

In some embodiments the apparatus is configured whereby the pointing device controls a cursor of a computer to which the apparatus is coupled. In some embodiments of the invention control of the cursor is performed by rotation of the pointing device. In some embodiments control of the cursor is performed by translational motion of the device or by a combination of translational and rotational motion of the device.

In some embodiments of the invention apparatus is provided configured to allow light emitting devices to be positioned on an object to be manipulated such as a skull or a product prototype. The apparatus is configured to determine an orientation of the object based on an image of the light emitting devices captured by the image capture device. In some embodiments the apparatus is arranged to provide an image corresponding to the object, the object being oriented in the image at an orientation corresponding to an actual orientation of the physical object.

In some embodiments of the invention the apparatus is provided with a headset having three or more light emitting devices, the headset being arranged to be worn on a head of a user. The apparatus is arranged to provide a display on a screen of an object or scene substantially as would be viewed by the user in a virtual environment. The apparatus is arranged to be responsive to movements of a user's head thereby to change for example a position and/or direction from which a scene or object is viewed.

In some embodiments of the invention a hand-held pointing device is provided in combination with the headset.

In some embodiments the apparatus is arranged to update the image corresponding to the object or scene in real time in response to movement of the pointing device and/or headset.

In some embodiments of the invention the apparatus is responsive to predetermined movements or sequences of movements of the pointing device 100. In some embodiments the apparatus is arranged to interpret a particular movement or sequence of movements as a mouse click or related signal. For example a particular movement could be interpreted as a trigger of an event in a game or other computer software application.

In some embodiments the apparatus is arranged to interpret a particular movement as representing a letter of the alphabet. In some such embodiments the apparatus is arranged to display the letter of the alphabet on a display of the apparatus.

In some embodiments movements such as a quick jerking tilting movement to the user's right (i.e. clockwise motion) may be recognised as a right mouse down event. A corresponding movement to the user's left (i.e. anticlockwise motion) may be recognised as a right mouse down event. Clockwise/anticlockwise movements may be arranged to trigger forwarding or rewinding through a video sequence.

In some embodiments a speed with which forwarding/rewinding of a video sequence is performed is dependent on an angle of tilt of the pointing device 100. In some embodiments the speed with which forwarding/rewinding of a video sequence is performed is dependent on a rate of movement of the pointing device in executing a prescribed movement or sequence of movements.

In some embodiments a backwards of forwards movement of the device is arranged to adjust an amount of zoom during (say) internet browsing.

It is to be understood that in some embodiments in which the third LED 113 is the same size as the first and second LEDs 111, 112 then in certain circumstances it may not be possible to avoid total occlusion of the first or second LEDs 111, 112 by the third LED 113. In order to overcome this problem, in some embodiments of the invention the first and second LEDs 111, 112 are arranged to have a larger area such that total occlusion of the first or second LEDs 111, 112 may be prevented. In some embodiments only one of the first or second LEDs 111, 112 has a larger area than the third LED 113.

In some embodiments of the invention more than three LEDs are provided. The LEDs may be arranged such that the camera will always be able to see at least three LEDs at substantially any given moment in time when the pointing device 100 is within the field of view of the image capture device 130 regardless of the direction in which the pointing device 100 is pointing.

For example, in some embodiments at extreme ranges of movement or rotation, such rotation through in excess of 180°, one or more LEDs 111,112, 113 may become occluded by a hand of a user, a portion of a housing of the pointing device 100 or by a portion of an object to which the device is mounted such as a skull of a wearer. The presence of additional LED devices increases the range of positions and orientations of the pointing device 100 in which the image capture device 130 is able to see at least three LEDs 111, 112, 113.

In some embodiments of the invention a value of the intensity of a signal detected by the image capture device 130 is used to determine the position of an LED in an image captured by the image capture device 130. In particular the intensity of the detected signal may be used to determine the position of one or more LEDs when two LEDs are in close proximity to one another, as discussed below.

FIG. 16 shows an image captured by the image capture device 130. The image contains images of the first, second and third LEDs 111, 112 and 113. It will be understood that in the case that overlap of the images of two or more LEDs occurs, the intensity of the signal corresponding to detected light will be greater in the region of overlap 116 (FIG. 16). In FIG. 16 portions of the images of the first and third LEDs 111, 113 overlap as shown. The apparatus may be arranged to determine a size and location of the area of overlap 116 of the images of two LEDs 111, 113 and non-overlapping regions of the images of the two LEDS 111, 113 thereby to allow a centroid of an area of an image corresponding to a given LED 111, 113 to be determined. It is to be understood that the apparatus may be configured to detect an area of overlap and corresponding centroids of images of any two or more LEDs of the apparatus.

It is to be understood that in some embodiments arranged to determine the boundary of an area of overlap of images of two or more LEDs the LEDs do not need to be of different colours. In some embodiments the first, second and third LEDs are all arranged to emit light of substantially the same frequency. In some embodiments the first, second and third LEDs are arranged to emit infra-red light.

It is to be understood that in some embodiments the pointing device may be arranged whereby the first and second LEDs 111, 112 are axially spaced along a thumb flexion-extension axis TFE, FIG. 17(a), or thumb abduction-adduction axis TAA, FIG. 17(b).

Movement of other joints may also be monitored. For example, the first and second LEDs 111, 112 may be axially spaced along the flexion-extension or abduction-adduction axes of rotation of a metacarpal-phalangeal joint FIG. 17(b), such as the second metacarpal-phalangeal joint or any other suitable joint.

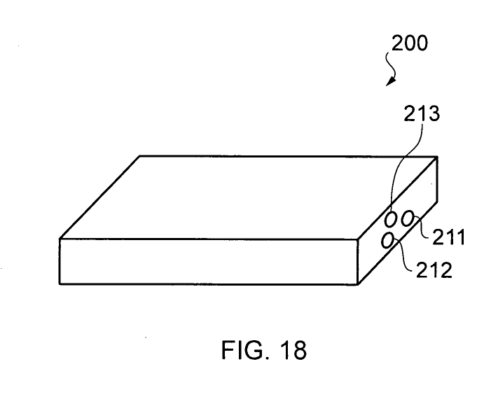

FIG. 18 shows a pointing device 200 according to an embodiment of the invention in which three LEDs 211, 212, 213 are provided in an end face of a housing. Other positions of the LEDs 211, 212, 213 are also useful. In some embodiments the housing is the housing of a mobile communications device such as a mobile telephone. In some embodiments the housing is the housing of a handset of a gaming device. In some embodiments the housing is the housing of a device arranged to control a position of a cursor or pointer on a display of a computing device. Other arrangements are also useful.

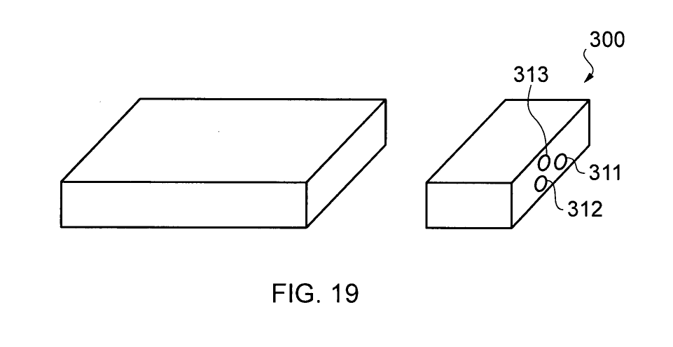

FIG. 19 shows a pointing device 300 in the form of a device attachable to another article such as a housing of a mobile telephone, remote control device, or any other suitable article. In a similar manner to the embodiment of FIG. 18 the device 300 has three LEDs 311, 312, 313 provided in a face thereof. The device 300 is arranged to enable any suitable object to be used to move the pointing device 300 by attachment of the device 300 thereto.

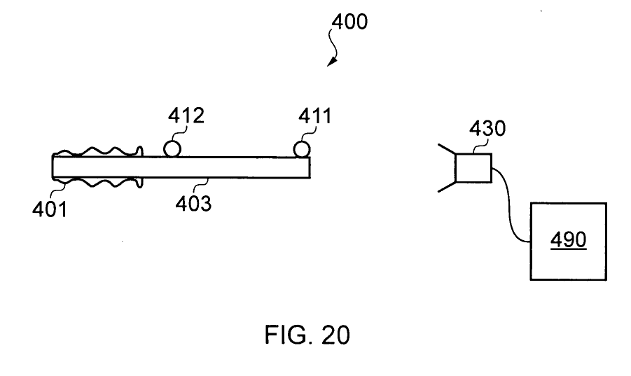

FIG. 20 shows a pointing device 400 according to an embodiment of the invention having first and second LEDs 411, 412 provided thereon. The LEDs 411, 412 are arranged to emit light of different respective colours. In some embodiments the colours are two different colours selected from amongst red, green and blue.

In some embodiments three or more LEDs are provided. The LEDs may each be of a different respective colour. Alternatively at least of the LEDs are of one colour and at least one LED is of a further colour.

The device 400 has a grip portion 401 arranged to be gripped in a palm of a user's hand and a pointer portion 403 arranged to protrude away from the grip portion 401. The first and second LEDs 411, 412 are provided at spaced apart locations along a length of the pointer portion 403.

In use, the device 400 is held a given distance from an image capture device 430 and computing apparatus 490 is arranged to acquire images of the pointing device 400.

In the embodiment shown the image capture device is a colour image capture device arranged to capture a colour image of the device 400 in a similar manner to image capture device 130 described above.

Since the device 400 has only two LEDs, the distance of the pointing device 400 from the image capture device 430 is provided to computing apparatus 490 arranged to calculate a position and orientation of the pointing device 400.

The distance may be provided to the computing apparatus 490 by a sensor arranged to detect a distance of the device 400 from the image capture device 430. Alternatively the distance may be provided to the computing apparatus 490 by a user, for example by entering the distance into the computing apparatus 490 by means of a keyboard or other suitable input device. Alternatively the user may be required to position the pointing device 400 a prescribed distance from the image capture device 430.

The computing apparatus 490 is arranged to capture an image of the pointing device 400 and to calculate an orientation of the pointing device 400 with respect to a set of 3D coordinates based on a knowledge of the physical distance between LEDs 411 and 412, a knowledge of the colour of LEDs 411, 412 and a knowledge of the distance of the pointing device 400 from the image capture device 430. Thus, the pointing device may be used to provide an input to computing apparatus thereby to control the apparatus.

In some embodiments a pointing device 100, 200, 300, 400 according to an embodiment of the invention is arranged to be coupled to an object whose position and orientation in 3D space it is required to know. As discussed above the object may be a gaming handset, a mobile telephone or any other suitable object. In some embodiments a pointing device 100, 200, 300, 400 according to an embodiment of the invention is provided with exercise or related equipment to enable a position of one or more portions of the equipment such as handles, foot pedals or any other required portion to be monitored. This has the advantage that motion of a hand, foot or any other suitable item may be monitored by the apparatus. In some embodiments this allows the computing apparatus to provide feedback to a user regarding motion of the user. For example, the apparatus may provided an indication as to how well a user is performing a given exercise routine. In some embodiments the computing apparatus may provide an indication as to how much energy a user is expending or generating.

In some embodiments, the information may be used too provide an animated image of a user performing an action, and an animated image showing how the action compares with a desired action. For example, a corresponding animated image may be shown in which the action is performed in a desired manner. Such apparatus may be arranged to provide real-time feedback to a user to allow the user to improve a manner in which the action is being performed.

It is to be understood that an advantage of using LEDs of different respective colours is that in some embodiments computing apparatus processing a captured image is able to resolve an ambiguity in determining an orientation of a pointing device by reference to a relative position of an LED of one colour with respect to an LED of another colour.

It is also to be understood that in some embodiments in which the image capture device captures images using detector elements sensitive to different respective ranges of wavelengths an increase in a reliability with which an orientation of the pointing device may be determined may be obtained.

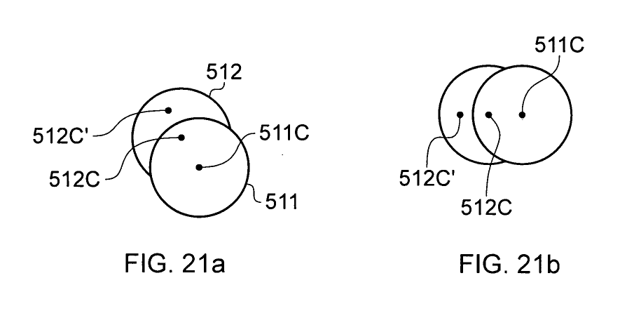

For example, FIG. 21 shows an image captured by an image capture device showing an LED 511 of one colour and an LED 512 of a different colour. It can be seen that a portion of LED 512 is occluded by LED 511. Consequently LED 512 shows as a substantially crescent-shaped feature of the image. It can be seen that a position of a centroid 512C′ of the crescent-shaped image of LED 512 in the image of FIG. 21(a) is different from a centroid 512C of LED 512 were LED 511 not present (since the image of LED 512 would then be a full circle in the embodiment shown).

Similarly, in FIG. 21(b), a centroid 512C′ of LED 512 in the image is different from a centroid 512C of LED 512 were LED 511 not present.

Consequently, if the computing apparatus calculates an amount of movement of LED 512 based on movement of the apparent centroid 512C′ rather than the true centroid 512C, an error in determination of movement of LED 512 will result.

Accordingly it is advantageous to employ an image capture device arranged to produce substantially independent images of LEDs or other indicia of different respective colours as described above.

Such an arrangement also allows LEDs to be positioned more closely together, the image capture device being capable of resolving LEDs of different respective colours even when a human eye might see only a combination of colours. For example, a red, green and blue LED placed closely together may give an impression to a user that light is arising from a single white or substantially white light emitter. A colour image capture device, however, would in some embodiments enable the red, green and blue LEDs to be readily distinguished from one another.

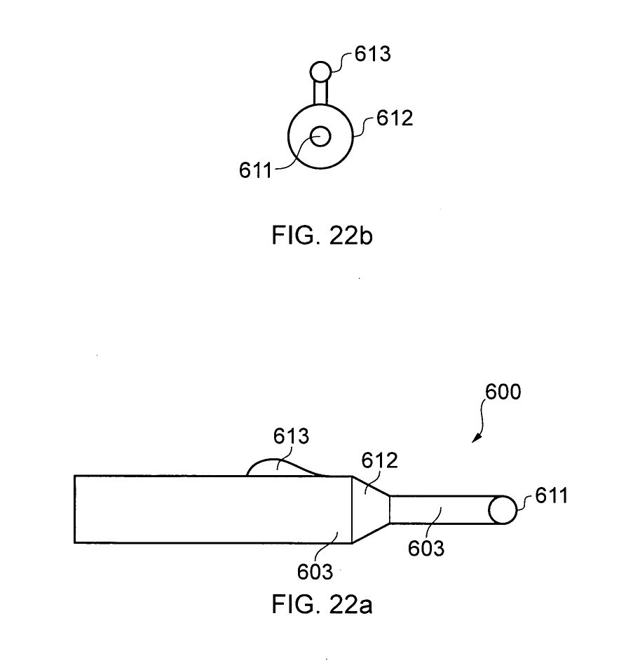

FIG. 22 shows an embodiment of the invention in which three LEDs 611, 612, 613 are provided along a length of a pointer portion 603 of a pointing device 600. The LEDs 611, 612, 613 are arranged to emit light of different respective colours selected from amongst red, green and blue. The apparatus is arranged to capture an image of the pointing device 600 by means of an image capture device and a computing device is arranged to determine a 3D orientation of the device 600 from a captured image.

The computing device may be provided with information in respect of a distance of the pointing device 600 from the camera (particularly when only two light emitting devices are provided, the two light emitting devices having different respective colours) and a distance between the respective light emitting devices.

Other light emitting devices are also useful in this and other embodiments described above. Light reflecting elements are also useful in this and other embodiments described above. In such cases it may be necessary to provide additional illumination in order to obtain a sufficiently strong signal from.

The use of reflective elements has the advantage that in the absence of illumination (i.e. when no radiation is incident on the elements) the elements may be made to be substantially invisible.

In some embodiments only two LEDs are provided, for example LEDs 611 and 612, or LEDs 611 and 613, or any other suitable combination of LEDs 611, 612 and 613. In some embodiments LEDs 611, 612 and 613 are each one of only two colours.

It is to be understood that in some embodiments the image capture device is provided with detector elements arranged to detect a colour other than red, green or blue. In some embodiments the image capture device is arranged to detect light having a wavelength or range of wavelengths in the infra-red range or ultra-violet range of wavelengths. In such embodiments one or more of the light emitting devices may be arranged to emit light of a corresponding wavelength or range of wavelengths.

In some embodiments of the invention a plurality of image capture devices may be provided. The image capture devices may be arranged at different positions to view a common area.

This has the advantage that the image capture devices may be used in combination to provide a more accurate determination of an orientation of a pointing device.

In some embodiments the apparatus is arranged to separately determine a position of the pointing device using images determined from each image capture device. If the positions are different, the apparatus may then be arranged to combine the separately determined positions to determine an ‘actual’ position of the pointing device, for example by determining a position midway between the two positions in the case that two image capture devices are used. More than two image capture devices may be used.

Furthermore, in the event that a view of one or more indicia (whether light emitting or light reflecting) of the pointing device by one of the image capture devices is obscured (for example due to a user's body or other object), there is an increased likelihood that the other image capture device will have an unobscured view of the pointing device. Furthermore, a total volume of space visible to the apparatus is increased using two capture devices suitably arranged as compared with only one capture device.

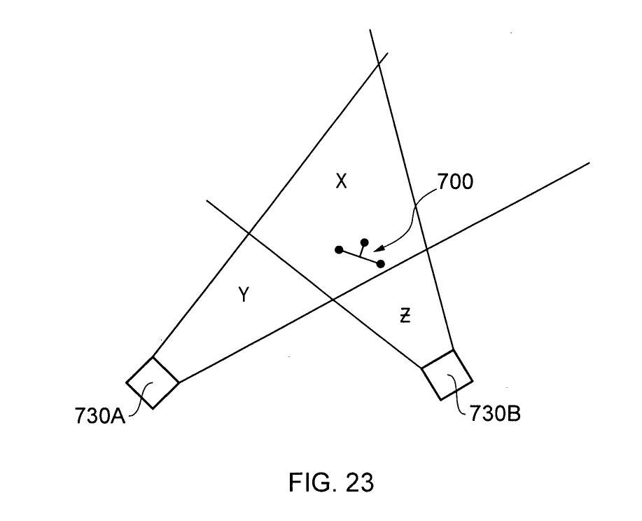

FIG. 23 is a schematic illustration showing an arrangement in which two image capture devices 730A and 730B are arranged to view a common volume labelled X in the figure. Image capture device 730A is also arranged to view volume Y which is not visible to capture device 730B. Capture device 730B is also arranged to view volume Z which is not visible to capture device 730A.

Thus, if pointing device 700 is within volume X and it is moved to volume Z, the apparatus will continue to be able to determine an orientation of the device 700 based on the image provided by capture device 730B provided a user or other object does not obscure the view of the pointing device 700 by the capture device 730B.

Similarly if the pointing device 700 is within volume X and it is moved to volume Y, the apparatus will continue to be able to determine an orientation of the device 700 based on the image provided by capture device 730A provided a user or other object does not obscure the view of the pointing device 700 by the capture device 730A.

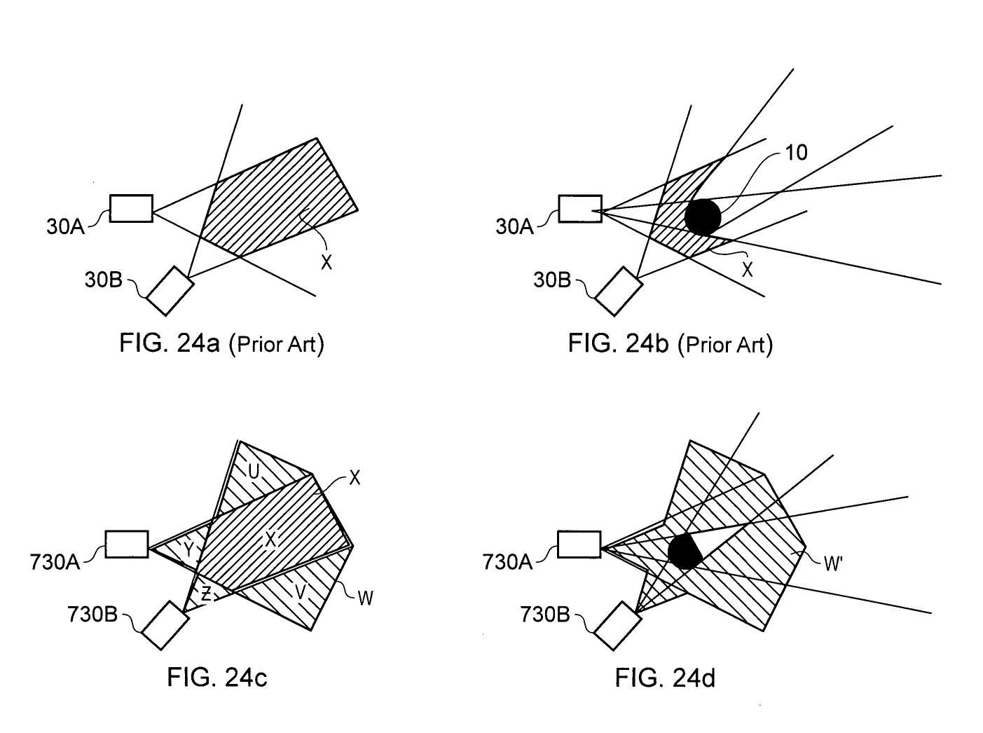

FIG. 24 (a), (b) shows a known object tracking system in which a pair of image capture devices 30A, 30B are arranged to capture images of an object being tracked, the devices 30A, 30B being arranged to view a common volume X. In FIG. 24 (a) no obstructions are present in volume X that would obscure a view of any portion of volume X.

However FIG. 24(b) shows a situation in which an object 10 is present, the object 10 being positioned so as to block a view by the image capture devices 30A, 30B of a region ‘behind’ the object 10. Thus, the size of common volume X visible to both image capture devices 30A, 30B is reduced, as shown in FIG. 24(b).

FIG. 24(c) shows a configuration of image capture devices 730A, 730B forming a part of an embodiment of the present invention. The arrangement of FIG. 24(c) is similar to that of FIG. 23 in which two image capture devices 730A, 730B are arranged to view a common volume of space X.

With reference to FIG. 24(c), certain volumes U, V, Y, Z are viewable by only one of the image capture devices 730A or 730B. However, this does not prevent apparatus according to an embodiment of the present invention employing image capture devices 730A, 730B from determining a position and orientation of a pointing device according to an embodiment of the invention positioned in one of volumes U, V, Y or Z with six degrees of freedom in the manner described herein. This is because an image from only one image capture device 730A, 730B is required in order to do so. Thus, apparatus according to an embodiment of the invention employing image capture devices 730A and 730B may determine a position and orientation of a pointing device located in shaded volume W as shown in FIG. 24(c), volume W comprising volumes U, V, X, Y and Z.

In the event that an object 10 blocks a portion of a view of the image capture devices 730A, 730B, the apparatus is still able to determine a position and orientation of the pointing device with six degrees of freedom provided the pointing device is located in the shaded area W′ of FIG. 24(d). Comparison of the shaded area W′ of FIG. 24(d) with the shaded area marked X in FIG. 24(b) demonstrates that embodiments of the present invention provide a considerable advantage over known technologies for determining position and orientation in that tracking with two cameras can be maintained over a considerably larger volume than prior art arrangements.

If both image capture devices 730A, 730B are able to acquire images, this may be considered in some embodiments to be a bonus feature in that it allows a comparison to made between the position and orientation of the pointing device as determined from an image captured by one capture device 730A, 730B and an image captured by the other capture device 730B, 730A. Thus, a precision with which a position and orientation of the pointing device is determined may be enhanced. For example, a position and orientation of the pointing device as determined by the capture device with the ‘best’ view of the pointing device may be determined to be the correct position and orientation. Alternatively, an ‘average’ position may be determined based on the positions determined by respective image capture devices. Other arrangements are also useful.

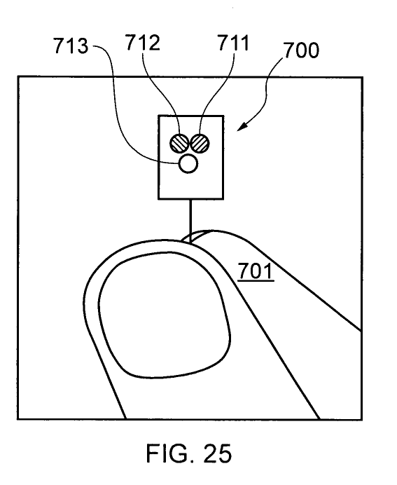

FIG. 25 shows a pointing device 700 according to an embodiment of the invention being held by fingers 701 of a user. It is to be understood that the device 700 shown is an example of a compact pointing device. The device may be attached to a user or other object to be tracked, for example to a microphone or lapel or name badge or other convenient object.

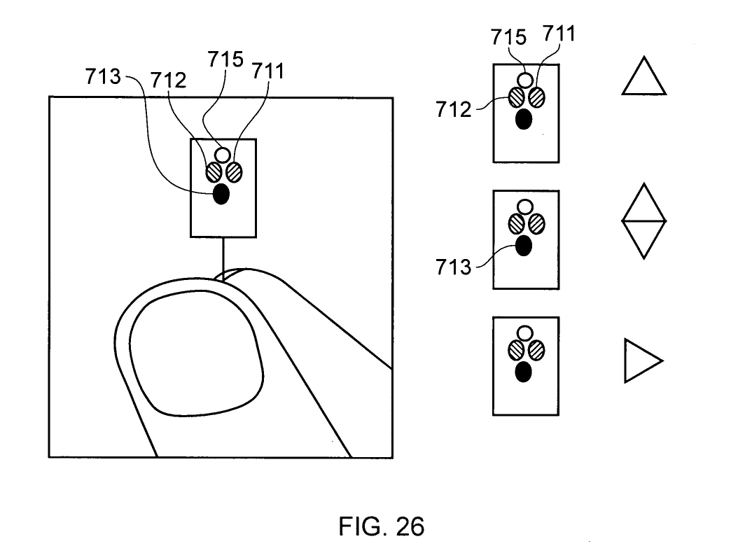

FIG. 26 shows a manner in which further information can be communicated by means of the pointing device 700 without compromising the determination of position and orientation of the pointing device 700 in use. In the embodiment shown, the pointing device has a fourth light emitting device 715. In some embodiments the fourth light emitting device 715 is a white light emitting device. Other devices are also useful, such as infra red light emitting devices, red, blue or green light emitting devices or any other suitable device emitting light detectable by the image capture device.

When it is required to communicate information, for example to communicate an event, such as the event that a user has moved a mouse up or down, or any other suitable event, the fourth light emitting device 715 may illuminate. In order to communicate a still further event, for example that a user has pressed a left mouse button, the fourth light emitting device 715 may illuminate and one of the other three light emitting devices 711, 712, 713 may be extinguished, such as light emitting device 713 (FIG. 26). Thus, at least three light emitting devices may still be viewed by an image capture device and a position and orientation of the pointing device 700 determined with six degrees of freedom.

It is to be understood that further event information may be communicated, for example a right mouse button selection made by a user may be communicated by extinguishing a different one of the other three light emitting devices 711, 712, 713, such as light emitting device 712 (FIG. 26).

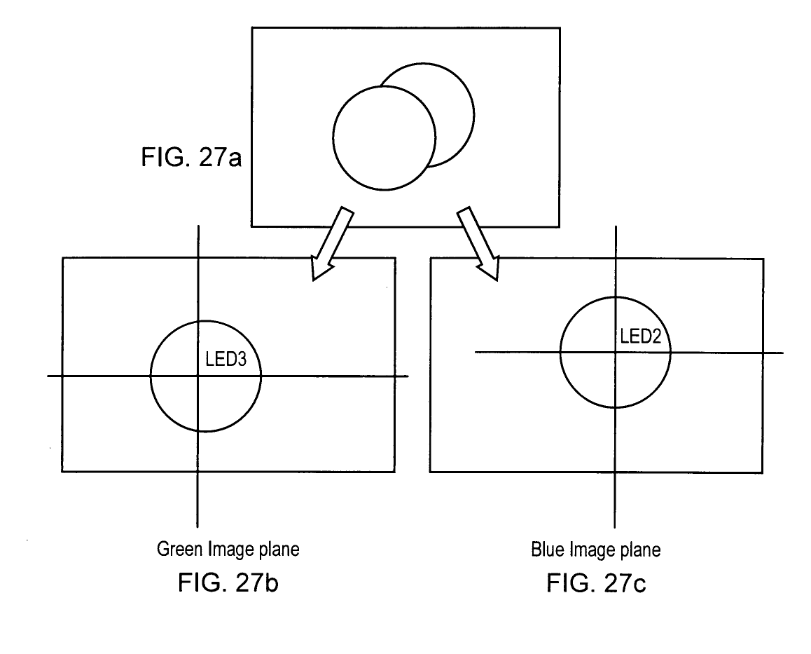

FIG. 27(a) shows an image obtained from an image capture device of a pointing device having a green light emitting device and a blue light emitting device. The image has been bloomed by defocusing of the image capture device in order to enlarge an apparent size of the light emitting devices.

FIG. 27(b) shows an image obtained using detector elements of the image capture device sensitive to green light (a ‘green image plane’ image) and FIG. 27(c) shows an image obtained using detector elements of the image capture device sensitive to blue light (a ‘blue image plane’ image). It is to be understood that a location of a centroid of the images of the blue and green light emitting devices may be made in a more accurate manner using the blue image plane and the green image plane images, respectively, compared with the image of FIG. 27(a) in which the blue and green image planes are superimposed on one another.

In some embodiments of the invention, an intensity of an image of an indicium of a marker member may be employed in order to obtain information about a position and orientation of the marker member.

It is known that an intensity of light emitted by a light emitting device such as a light emitting diode can vary with direction in which emitted light propagates from the device. A peak in intensity typically occurs in a forward direction, the intensity decreasing at increasing angles with respect to the forward direction.

Thus, an intensity of light received by an image capture device from a light emitting device will depend upon an angle between a line drawn from the image capture device to the light emitting device (referred to herein as a ‘camera-source axis’ (CSA) and a line from the source along a ‘forward throw’ axis (FTA) of the source. The forward throw axis may be defined as an axis of forward thrown of light from the light emitting device. For example, the forward throw axis may be defined as an axis coincident with an optic axis of a lens of the light emitting device. For example, some light emitting diodes have a lens integrally formed with a packaging of the LED, the lens in some devices being formed from a plastics material.

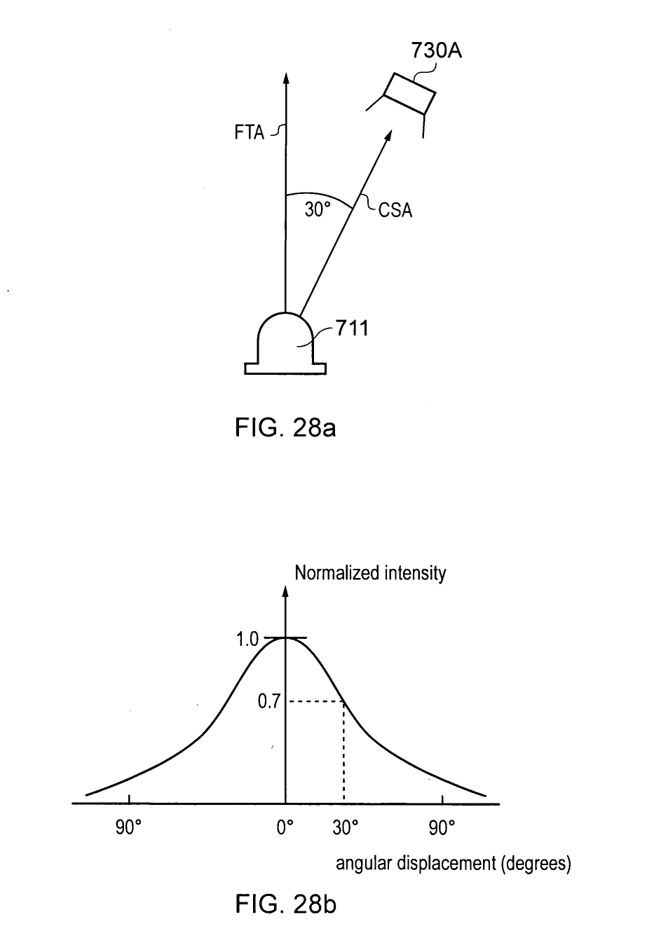

FIG. 28 illustrates the relative positions of the forward throw axis FTA and camera-source axis CSA in a particular configuration. A light emitting device 711 in the form of a light emitting diode is shown with its FTA pointing upwards as viewed in FIG. 28 (a). An image capture device 730A is shown in the figure, and the CSA axis marked in the figure.

A plot of normalised intensity is shown in FIG. 28(b) as a function of angular displacement. It is to be understood that the value of angular displacement is equivalent to the angle between the FTA and CSA in the case that the intensity is measured using the image capture device 730A.

In determining a distance of a light emitting device from the image capture device, a knowledge of the intensity of light received at the image capture device would alone be insufficient. This is because intensity is not only a function of distance of the light source from the image capture device as discussed above. Accordingly, first and second light emitting devices may be employed to resolve the ambiguity.

In some embodiments the first and second light emitting devices are of different respective colours. This allows a position of a centre of each light emitting device to be determined even when images of the devices as captured by an image capture device appear to overlap.

In one embodiment the two light emitting devices also have different respective normalised intensities as a function of angle between the camera-source axis and the forward-throw axis. Thus, one of the light emitting devices is arranged to exhibit a relatively small change in intensity as detected by an image capture device as an angle between the forward-throw axis and the camera-source axis is changed, over a prescribed range of angles. So-called ‘wide angle lens’ devices fall within this category.

The other light emitting device, in contrast, is arranged to exhibit a relatively large change in a corresponding intensity as a function of angle between the forward-throw axis and the camera-source axis over a prescribed range of angles.

Thus, if (say) a red LED being a wide-angle lens device and a blue LED having a relatively low angle lens are employed it will be understood that when an angle between the forward-throw axis of the marker member and the camera-source axis is changed, an intensity of the blue LED as detected by the image capture device is likely to change more rapidly than an intensity of the red LED as detected by the image capture device, at least over a prescribed range of angles. However, when the marker member is moved towards or away from the camera, i.e. along a camera-source axis, the relative intensities of the blue and red LEDs will remain substantially constant. A distance between the blue and red LEDs, however, will change, an amount of the change for a given distance moved depending on a distance of the marker member from the image capture device.

An advantage of the use of such a method is that only two LEDs are required. Furthermore colours from opposite ends of the visible spectrum may be used (such as red and blue) without a requirement to use an intermediate colour (such as green), allowing improved colour plane separation.

In some embodiments a measurement of intensity of light sources in order to determine a position and orientation of a marker member as described herein may be used to support calculations of position and orientation of a marker member using other methods not requiring intensity measurements to be made, such as other methods described herein.

For example, position and orientation determination by means of intensity measurements may be used to support a method requiring three or more light sources in order to determine position and orientation. Thus, in the event that one of the three light sources becomes obscured or fails, preventing a determination of position and orientation, position and orientation may be determined by means of the two remaining light emitting devices. In some embodiments having three light emitting devices, the devices are arranged to have different respective variations in normalised intensity as a function of angular displacement. Other arrangements are also useful.

It is to be understood that reference herein to a pointing device includes reference to a marker member whose position and orientation is to be determined with six degrees of freedom even if the marker member is not being used as a ‘pointing device’ per se.

Embodiments of the invention may be understood with reference to the following numbered paragraphs:

1. Computer input apparatus comprising:
an image capture device; and
a marker member comprising at least three non-colinear reference indicia,
the apparatus being configured to capture an image of the reference indicia and to determine a position and orientation of the marker member with respect to a reference frame,
the apparatus being further configured wherein a size of an area of the image captured by the apparatus corresponding to one or more of the reference indicia is expanded relative to a corresponding area of a portion of an image of the reference indicia that would be obtained under in-focus conditions whereby a position of a centroid of each of the one or more reference indicia in the image may be determined with increased precision.
   2. Apparatus as claimed in claim 1 wherein expansion of the area of the image occupied by the at least one indicia is obtained by defocus of the image.
   3. Apparatus as claimed in claim 2 wherein defocus of the image is performed by optical means.
   4. Apparatus as claimed in claim 2 wherein defocus of the image is performed electronically.
   5. Apparatus as claimed in any preceding claim wherein at least one of the reference indicia comprises a light source.
   6. Apparatus as claimed in claim 5 wherein the at least three non-colinear reference indicia are provided by a first light source, a second light source and a third light source.
   7. Apparatus as claimed in claim 6 wherein the first light source is arranged to emit light having a first spectral characteristic, the second light source is arranged to emit light of a second spectral characteristic and the third light source is arranged to emit light of a third spectral characteristic different from the first spectral characteristic.
   8. Apparatus as claimed in claim 7 wherein the image capture device is provided with a plurality of detector elements, a first detector element being responsive to wavelengths in a first range of wavelengths, the apparatus being operable to acquire a first image by means of the first detector element, a second detector element being responsive to wavelengths in a second range of wavelengths different from the first range of wavelengths, the apparatus being operable to acquire a second image by means of the second detector element, wherein the first range of wavelengths includes at least some wavelengths of the first spectral characteristic and the second range of wavelengths includes at least some wavelengths of the third spectral characteristic.
   9. Apparatus as claimed in claim 8 arranged whereby the first and third spectral characteristics and the first and second ranges of wavelengths are selected such that for a given intensity of light emitted by respective first and third light sources, an intensity of light detected by the first detector element from the first light source is greater than an intensity of light from the third light source.
   10. Apparatus as claimed in claim 8 or claim 9 arranged whereby the first and third spectral characteristics and the first and second ranges of wavelengths are selected such that for a given intensity of light emitted by respective first and third light sources, an intensity of light detected by the second detector element from the third light source is greater than an intensity of light from the first light source.
   11. Apparatus as claimed in any one of claims 8 to 10 arranged to determine a position in the first image of a centroid of a portion of the first image corresponding to the first light source and a position in the second image of a centroid of a portion of the second image corresponding to the third light source.
   12. Apparatus as claimed in any one of claims 7 to 11 wherein the first and third spectral characteristics correspond to different respective colours.
   13. Apparatus as claimed in any one of claims 7 to 12 wherein the first and second spectral characteristics correspond to substantially the same colour.
   14. Apparatus as claimed in any one of claims 7 to 12 wherein the first and second spectral characteristics correspond to different respective colours.
   15. Apparatus as claimed in claim 14 depending through claim 12 wherein the first, second and third spectral characteristics each correspond to a different respective colour.
   16. Apparatus as claimed in claim 15 wherein the image capture device comprises a third detector element responsive to wavelengths in a third range of wavelengths and arranged to capture a third image, the third range of wavelengths including at least some wavelengths of the second spectral characteristic.
   17. Apparatus as claimed in any one of claims 12 to 16 wherein the colour of each light source is selected from amongst red, green and blue.
   18. Apparatus as claimed in claim 6 or any one of claims 7 to 17 depending through claim 6 wherein an intensity of light emitted by at least one of the light sources may be changed whereby the apparatus is able to identify whether a portion of an image corresponding to a light source corresponds to the first, second or third light source by means of a prescribed change in intensity of light emitted by the at least one of the light sources.
   19. Apparatus as claimed in claim 18 as dependent on claim 6 or any one of claims 7 to 11 depending through claim 6 wherein the first, second and third light sources are each arranged to emit light of substantially the same wavelength as one another.
   20. Apparatus as claimed in any preceding claim wherein the first and/or second reference indicia are arranged to be of a larger area than the third reference indicium whereby occlusion of an image of the first and/or second reference indicia by the third reference indicium may be substantially avoided.
   21. Apparatus as claimed in claim 6 or any one of claims 7 to 20 depending through claim 6 wherein the apparatus is configured to detect an area of overlap of images of two or more of the light sources by determining a location of any area of increase in light intensity in a captured image due to overlap of the images.
   22. Apparatus as claimed in claim 21 arranged to determine a centroid of an area of the captured image corresponding to one of the light sources by reference to any said area of overlap between the area corresponding to the one light source and an area corresponding to another one of the light sources, and an area of the image corresponding to said one of the light sources that is not overlapping an area corresponding to said another one of the light sources.
   23. Apparatus as claimed in any preceding claim wherein the marker member is arranged to be held in a hand of a user.
   24. Apparatus as claimed in any preceding claim wherein the marker member is arranged to be attached to a user.
   25. Apparatus as claimed in claim 23 or claim 24 wherein the marker member is arranged to be positioned whereby a pair of the reference indicia are provided in a mutually spaced apart configuration substantially coincident with an axis of rotation of an anatomical joint.
   26. Apparatus as claimed in claim 25 wherein the marker member is arranged whereby the first and second reference indicia are provided in the mutually spaced apart configuration substantially coincident with the axis of rotation of the anatomical joint.
   27. Apparatus as claimed in claim 25 or 26 wherein the axis of rotation corresponds to an abduction-adduction axis of the wrist.
   28. Apparatus as claimed in claim 25 or 26 wherein the axis of rotation corresponds to a carpo-1^{st} metacarpal joint.
   29. Apparatus as claimed in claim 25 or 26 wherein the axis of rotation corresponds to a second metacarpal-phalangeal joint.
   30. Apparatus as claimed in any preceding claim wherein the image capture device is provided with a polarising element arranged to reduce an amount of light incident on a detector of the image capture device.
   31. Computer input apparatus comprising
an image capture device; and
a marker member comprising at least three non-colinear reference indicia, the marker member being arranged to be held by a user or attached to a body of a user such that a pair of reference indicia are provided in a mutually spaced apart configuration substantially coincident with an anatomical axis of rotation of a joint of the user,
the apparatus being configured to capture an image of the reference indicia and to determine a position and orientation of the marker member with respect to a reference position.
   32. Apparatus as claimed in claim 31 wherein the structure is arranged such that one of each of the pair of reference indicia are provided at locations substantially coincident with the axis of rotation, the pair of reference indicia being axially spaced with respect to one another.
   33. Apparatus as claimed in claim 31 or 32 configured to form an image of the reference indicia wherein an area of the image occupied by at least one of the indicia is expanded relative to a corresponding area of an image of the indicia under in-focus conditions whereby a position of a centroid of the area of the image occupied by each of the indicia may be determined with increased precision.
   34. Apparatus as claimed in any one of claims 31 to 33 wherein the anatomical axis of rotation corresponds to an abduction-adduction axis of the wrist.
   35. Apparatus as claimed in any one of claims 31 to 33 wherein the anatomical axis of rotation corresponds to a carpo-1^{st} metacarpal joint.
   36. Apparatus as claimed in any one of claims 31 to 33 wherein the anatomical axis of rotation corresponds to a second metacarpal-phalangeal joint.
   37. Apparatus as claimed in any one of claims 31 to 36 arranged to be held in a hand of the user.
   38. Apparatus as claimed in any one of claims 21 to 33 arranged to be attached to a head of the user.
   39. Apparatus as claimed in any one of claims 31 to 38 comprising a plurality of marker members.
   40. Apparatus as claimed in claim 39 comprising a pair of marker members arranged to be held in respective left and right hands of the user.
   41. Apparatus as claimed in claim 39 or claim 40 comprising at least one marker member arranged to be held in a hand of the user and a marker member arranged to be supported on a head of the user.
   42. Apparatus as claimed in any one of claims 31 to 41 wherein the apparatus is further configured such that a size of an area of the image captured by the apparatus corresponding to one or more of the reference indicia is expanded relative to a corresponding area of a portion of an image of the reference indicia that would be obtained under in-focus conditions whereby a position of the centroid of each of the one or more reference indicia in the image may be determined with increased precision.
   43. Apparatus as claimed in claim 42 wherein expansion of the area of the image occupied by the at least one indicia is obtained by defocus of the image.
   44. Apparatus as claimed in claim 43 wherein defocus of the image is performed by optical means.
   45. Apparatus as claimed in claim 43 wherein defocus of the image is performed electronically.
   46. Apparatus as claimed in any one of claims 31 to 45 wherein at least one of the reference indicia comprises a light source.
   47. Apparatus as claimed in claim 46 wherein the at least three non-colinear reference indicia are provided by a first light source, a second light source and a third light source, respectively.

Throughout the description and claims of this specification, the words “comprise” and “contain” and variations of the words, for example “comprising” and “comprises”, means “including but not limited to”, and is not intended to (and does not) exclude other moieties, additives, components, integers or steps.

Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith.

1. Computer input apparatus comprising:
an image capture device; and
a marker member comprising at least two reference indicia,
at least a first reference indicium being arranged to emit or reflect light having a first spectral characteristic, and
at least a second reference indicium being arranged to emit or reflect light having a second spectral characteristic different from the first spectral characteristic,
the image capture device being arranged to distinguish light of said first spectral characteristic from light of said second spectral characteristic thereby to distinguish the at least a first reference indicium from the at least a second reference indicium,
the apparatus being configured to capture an image of the at least two reference indicia and to determine by means of said image a position and orientation of the marker member with respect to a reference frame.

2. Apparatus as claimed in claim 1 wherein light of the first spectral characteristic corresponds to light of a first colour and light of the second spectral characteristic corresponds to light of a second colour different from the first colour.

3. Apparatus as claimed in claim 2 wherein the first and second colours are each a different one selected from amongst red, green and blue.

4. Apparatus as claimed in any preceding claim comprising at least a third reference indicium arranged to emit or reflect light of a third spectral characteristic.

5. Apparatus as claimed in claim 4 wherein the third spectral characteristic corresponds substantially to the first or second spectral characteristics.

6. Apparatus as claimed in claim 4 wherein the third spectral characteristic is sufficiently different from the first and second spectral characteristics to be distinguishable by the image capture device from indicia emitting or reflecting light of the first or second spectral characteristics.

7. Apparatus as claimed in claim 5 or claim 6 wherein the third spectral characteristic corresponds to a colour.

8. Apparatus as claimed in claim 7 wherein the colour is one selected from amongst red, green and blue.

9. Apparatus as claimed in claim 8 depending through claim 3 wherein light of the first, second and third spectral characteristics each corresponds to a different respective colour.

10. Apparatus as claimed in claim 4 or any of claims 5 to 9 depending through claim 4 wherein the first, second and third reference indicia are arranged to non-colinear.

11. Apparatus as claimed in any preceding claim wherein the image capture device is provided with a plurality of detector elements,
a first detector element being responsive to wavelengths in a first range of wavelengths, the apparatus being operable to acquire a first image by means of the first detector element, and
a second detector element being responsive to wavelengths in a second range of wavelengths different from the first range of wavelengths,
the apparatus being operable to acquire a second image by means of the second detector element, wherein the first range of wavelengths includes at least some wavelengths of the first spectral characteristic and the second range of wavelengths includes at least some wavelengths of the second spectral characteristic.

12. Apparatus as claimed in claim 11 arranged whereby the first spectral characteristic and the first and second ranges of wavelengths are selected such that for a given intensity of light emitted or reflected by the at least a first indicium, an intensity of light detected by the first detector element from the at least a first indicium is greater than an intensity of light detected by the second detector element from the at least a first indicium.

13. Apparatus as claimed in claim 11 or claim 12 arranged whereby the second spectral characteristic and the first and second ranges of wavelengths are selected such that for a given intensity of light emitted or reflected by the at least a second indicium, an intensity of light detected by the second detector element from the at least a second indicium is greater than an intensity of light detected by the first detector element from the at least a second indicium.

14. Apparatus as claimed in any one of claims 11 to 13 arranged to determine a position in the first image of a centroid of a portion of the first image corresponding to the at least a first indicium and a position in the second image of a centroid of a portion of the second image corresponding to the at least a second indicium.

15. Apparatus as claimed in any one of claims 11 to 14 depending through claim 4 wherein the image capture device comprises a third detector element responsive to wavelengths in a third range of wavelengths and arranged to capture a third image, the third range of wavelengths including at least some wavelengths of the third spectral characteristic.

16. Apparatus as claimed in claim 15 depending through claim 12 or 13 arranged whereby
the first spectral characteristic and the first, second and third ranges of wavelengths are selected such that for a given intensity of light emitted or reflected by the at least a first indicium, an intensity of light detected by the first detector element from the at least a first indicium is greater than an intensity of light detected by the second or third detector elements from the at least a first indicium;
the second spectral characteristic and the first, second and third ranges of wavelengths are selected such that for a given intensity of light emitted or reflected by the at least a second indicium, an intensity of light detected by the second detector element from the at least a second indicium is greater than an intensity of light detected by the first or third detector elements from the at least a second indicium; and
the third spectral characteristic and the first, second and third ranges of wavelengths are selected such that for a given intensity of light emitted or reflected by the at least a third indicium, an intensity of light detected by the third detector element from the at least a third indicium is greater than an intensity of light detected by the first or second detector elements from the at least a third indicium.

17. Apparatus as claimed in any preceding claim wherein one reference indicium is arranged to be of a larger area another reference indicium whereby occlusion of an image of the one reference indicia by the other reference indicium may be substantially avoided.

18. Apparatus as claimed in any preceding claim wherein the apparatus is configured to detect an area of overlap in an image of two or more of the indicia by determining a location of any area of increase in light intensity in a captured image due to overlap of indicia.

19. Apparatus as claimed in claim 18 arranged to determine a centroid of an area of the captured image corresponding to one of the indicia by reference to any said area of overlap between the area corresponding to the one indicium and an area corresponding to another indicium, and an area of the image corresponding to said one of the indicia that is not overlapping an area corresponding to said another one of the indicia.

20. Apparatus as claimed in any preceding claim wherein the marker member is arranged to be held in a hand of a user.

21. Apparatus as claimed in any preceding claim wherein the marker member is arranged to be attached to a user.

22. Apparatus as claimed in claim 20 or claim 21 wherein the marker member is arranged to be positioned whereby a pair of the reference indicia are provided in a mutually spaced apart configuration substantially coincident with an axis of rotation of an anatomical joint.

23. Apparatus as claimed in claim 22 wherein the marker member is arranged whereby the first and second reference indicia are provided in the mutually spaced apart configuration substantially coincident with the axis of rotation of the anatomical joint.

24. Apparatus as claimed in claim 22 or 23 wherein the axis of rotation corresponds to an abduction-adduction axis of the wrist.

25. Apparatus as claimed in claim 22 or 23 wherein the axis of rotation corresponds to one selected from amongst a carpo-1^{st} metacarpal joint and a second metacarpal-phalangeal joint.

26. Apparatus as claimed in any preceding claim wherein the image capture device is provided with a polarising element arranged to reduce an amount of light incident on a detector of the image capture device.

27. Apparatus as claimed in any preceding claim wherein at least one of the reference indicia comprises a light source.

28. Apparatus as claimed in any preceding claim wherein each of the reference indicia comprises a light source.

29. Apparatus as claimed in any preceding claim wherein a size of an area of the image captured by the apparatus corresponding to one or more of the reference indicia is expanded relative to a corresponding area of a portion of an image of the reference indicia that would be obtained under in-focus conditions whereby a position of a centroid of each of the one or more reference indicia in the image may be determined with increased precision.

30. Apparatus as claimed in claim 29 wherein expansion of the area of the image corresponding to the one or more of reference indicia is obtained by defocus of the image.

31. Apparatus as claimed in claim 30 wherein defocus of the image is performed by optical means.

32. Apparatus as claimed in claim 30 or 31 wherein defocus of the image is performed electronically.

33. Apparatus as claimed in any preceding claim wherein an intensity of light emitted or reflected by at least one of the indicia may be changed whereby the apparatus is able to identify which indicium a portion of an image corresponds to by means of a prescribed change in intensity of light emitted or reflected by the at least one of the indicia.

34. Apparatus as claimed in any preceding claim comprising a plurality of image capture devices.

35. Apparatus as claimed in claim 34 wherein at least a first image capture device is arranged to capture an image from a region of space not captured by at least a second image capture device.

36. Apparatus as claimed in claim 35 wherein the regions of space captured by the at least a first image capture device and the at least a second image capture device have at least a portion in common.

37. Computer input apparatus comprising
an image capture device; and
a marker member comprising at least three non-colinear reference indicia, the marker member being arranged to be held by a user or attached to a body of a user such that a pair of reference indicia are provided in a mutually spaced apart configuration substantially coincident with an anatomical axis of rotation of a joint of the user,
the apparatus being configured to capture an image of the reference indicia and to determine a position and orientation of the marker member with respect to a reference position.

38. Apparatus as claimed in claim 37 wherein the structure is arranged such that one of each of the pair of reference indicia are provided at locations substantially coincident with the axis of rotation, the pair of reference indicia being axially spaced with respect to one another.

39. Apparatus as claimed in any one of claim 37 or 38 wherein the anatomical axis of rotation corresponds to an abduction-adduction axis of the wrist.

40. Apparatus as claimed in any one of claims 37 to 39 wherein the anatomical axis of rotation corresponds to a carpo-1^{st} metacarpal joint.

41. Apparatus as claimed in any one of claims 37 to 40 wherein the anatomical axis of rotation corresponds to a second metacarpal-phalangeal joint.

42. Apparatus as claimed in any one of claims 37 to 41 arranged to be held in a hand of the user.

43. Apparatus as claimed in any one of claims 37 to 42 arranged to be attached to a head of the user.

44. Apparatus as claimed in any one of claims 37 to 43 comprising a plurality of marker members.

45. Apparatus as claimed in claim 44 comprising a pair of marker members arranged to be held in respective left and right hands of the user.

46. Apparatus as claimed in claim 44 or claim 45 comprising at least one marker member arranged to be held in a hand of the user and a marker member arranged to be supported on a head of the user.

47. Apparatus as claimed in any one of claims 37 to 46 wherein the apparatus is further configured such that a size of an area of the image captured by the apparatus corresponding to one or more of the reference indicia is expanded relative to a corresponding area of a portion of an image of the reference indicia that would be obtained under in-focus conditions whereby a position of the centroid of each of the one or more reference indicia in the image may be determined with increased precision.

48. Apparatus as claimed in claim 47 wherein expansion of the area of the image occupied by the at least one indicia is obtained by defocus of the image.

49. Apparatus as claimed in claim 48 wherein defocus of the image is performed by optical means.

50. Apparatus as claimed in claim 48 or 49 wherein defocus of the image is performed electronically.

51. Apparatus as claimed in any one of claims 37 to 50 wherein at least one of the reference indicia comprises a light source.

52. Apparatus as claimed in claim 51 wherein the at least three non-colinear reference indicia are provided by a first light source, a second light source and a third light source, respectively.

53. Apparatus substantially as hereinbefore described with reference to the accompanying drawings.
